(19) United States
(12) Patent Application Publication
(10) Pub. No.: US 2004/0225898 A1
(43) Pub. Date: Nov. 11, 2004

(54) System and method for ubiquitous network access

(76) Inventors: D. Gabriel Frost, Kirkland, WA (US); David D. Miller, Seattle, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/766,670

(22) Filed: Jan. 27, 2004

Related U.S. Application Data
(60) Provisional application No. 60/443,295, filed on Jan. 28, 2003.

(51) Int. Cl. H04L 9/00

(52) U.S. Cl. 713/201

(57) ABSTRACT

Disclosed embodiments significantly increase the power and flexibility of public access network roaming systems. This is accomplished in one or more embodiments by requiring no new software or hardware to be installed by the end user. Further, an end user's service provider can be automatically determined. If a pre-negotiated network sharing agreement does not exist between the network provider and service provider, a network sharing agreement can be dynamically facilitated, even if the network provider and the service provider have no prior business relationship; while protecting the business and financial interests of both providers. Embodiments allow for a clearinghouse for revenue assurance. Embodiments contemplate a scalable, distributable system. Embodiments allow for variable access charges among and within venues and a wide variety of service plans for end users. Embodiments remain backward compatible with legacy systems for maximum flexibility.

### CROSS-REFERENCE TO RELATED APPLICATION

This application claims the benefit under 35 U.S.C. §119(e) of U.S. Provisional Patent Serial Application No. 60/443,295, entitled “SYSTEM AND METHOD FOR UBIQUITOUS NETWORK ACCESS,” filed Jan. 28, 2003, where this provisional application is incorporated herein by reference in its entirety.

### TECHNICAL FIELD

The present disclosure relates generally to network communications, and in particular but not exclusively, relates to the facilitation of ubiquitous network access across all networks from the point of view of the end-user. The operators of the networks, the end user, and whoever normally provides network services to the end user do not need to have a prior relationship for network access to occur.

### BACKGROUND INFORMATION

The utility of networking computing devices is well established. Homes, businesses, schools, and other organizations have established internal networks to create more productive workspaces. The utility and increased productivity provided by these internal networks has been substantial. Recently, members of the aforementioned organizations have realized productivity and utility can be boosted if the number of locations from which the organization's internal networks can be accessed is increased in number. Similarly, these same individuals wish to access the aforementioned external networks from a larger number of locations.

Physical replication of the organization's internal networks in all possible locations where access might be desired is not practical. Consequently, organizations have been searching for an alternate way to meet their members' desires for network access from a broad variety of locations.

The concept of public network access was developed. A network operator unrelated to the organization installs the necessary networking equipment at a particular location. An individual from another organization can utilize this public network access service to, for example, access his or her organization's internal networks or even external networks like the Internet. The operator of the public network access location usually collects a fee from the individual or the individual's organization for enabling this access.

Advances in physical network connectivity—particularly wireless networking technologies—have made public access networks more popular. Individuals wishing to access these public networks, however, have found the process of finding a usable network connection difficult. This difficulty goes beyond making the actual physical connection to the network.

For a variety of reasons, accessing any network requires the implementation of certain permissions. Authentication, authorization, and accounting (including verifiability) for the individual's session on the public access networks are problematic. When an individual steps into a location containing a public access network, the individual and the network operator may have no prior relationship. This requires the individual to create a relationship with the network operator in order to gain access to the network.

If the same individual visits a different location seeking public network access, it is likely a different network operator offers this service. The individual must create a second business relationship with this operator. This problem is magnified with each new location the individual visits seeking public network access.

### BRIEF SUMMARY OF THE INVENTION

One aspect provides a system. The system includes at least one port component through which an end user needs to be authenticated and authorized in order to access a network resource via a network provider's network. The port component is able to enforce an access policy and to apply rules of a service provider of the end user during the end user's use of the network provider's network. At least one first director component is communicatively coupled to the port component to provide the access policy to be used in connection with the network provider's grant of access to its network. At least one second director component is communicatively coupled to the first director component to provide the access policy to the first director component in connection with the service provider's request for access to the network provider's network on behalf of its end user and in connection with authentication and authorization of the end use. A home provider register (HPR) component is communicatively coupled to the first director component to be used by the first director component in connection with determination of a service provider of the end user.

### BRIEF DESCRIPTION OF THE SEVERAL VIEWS OF THE DRAWINGS

Non-limiting and non-exhaustive embodiments are described with reference to the following figures.

FIG. 1 is a high-level network diagram in accordance with one embodiment.

FIG. 2 is high-level representation of the processes involved in one embodiment.

FIG. 3 illustrates the top level of the service provider determination process in accordance with an embodiment.

FIG. 4 illustrates the portion of the service provider determination process that occurs when the process is informed via the existence of a token(s) on the end users device in accordance with an embodiment.

FIG. 5 illustrates the portion of the service provider determination process that occurs when the process is uninformed due to the absence of a token(s) on the end users device in accordance with an embodiment.

FIG. 6 illustrates the dynamic network share process in accordance with an embodiment.

FIG. 7 illustrates the brand import process in accordance with an embodiment.

FIG. 8 illustrates the top level of the authentication and authorization process in accordance with an embodiment.

FIG. 9 illustrates the portion of the authentication and authorization process that is the authentication process in accordance with an embodiment.

FIG. 10 illustrates the portion of the authentication and authorization process that is the authorization process in accordance with an embodiment.

FIG. 11 illustrates the heartbeat process in accordance with an embodiment.

FIG. 12 illustrates the billing process in accordance with an embodiment.

FIG. 13 illustrates the clearinghouse process in accordance with an embodiment.

FIG. 14 illustrates an embodiment of the provider revocation process wherein it is possible to render a part or parts of the technology unable to function or function to full capability.

FIG. 15 is a block diagram illustrating a computing appliance in accordance with an embodiment.

FIG. 16 illustrates which processes occur within the Port and Director components in accordance with an embodiment. Each process outlines an embodiment of algorithms that perform a specific task.

FIG. 17 illustrates group containers as pertaining to embodiments.

FIG. 18 illustrates an embodiment of the Open Search Interface XML extension language.

FIGS. 19a-19c illustrate an embodiment that allows a network provider to segment different areas of a single venue to enable application of different business rules to different areas.

FIG. 20 illustrates embodiments that describe which entities deploy Port and Director components, where they are physically deployed, and one non-limiting example of how the components intercommunicate.

FIG. 21 illustrates an embodiment that supports the 802.1× protocol for authentication.

FIG. 22 illustrates an embodiment that enables compatibility with legacy roaming system architectures.

### DETAILED DESCRIPTION

Embodiments of systems and methods for ubiquitous network access are described herein. In the following description, numerous specific details are given to provide a thorough understanding of embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The applicant seeks to solve the aforementioned problems through the implementation of the various embodiments described herein. Authentication, authorization, and accounting will be simplified so the number of business relationships required for the individual to achieve ubiquitous access to networks is reduced. Furthermore, the creation and utility of network sharing agreements between network operators will be simplified and greatly reduced out of necessity for scalability and usability in an extremely fragmented, high-growth market.

Accurate description of embodiments requires the use of several terms. While other terms will be defined by context or specifically as needed during the description of the embodiments, certain terms are defined below for purposes of providing a clear explanation of such embodiments. It is understood that these terms are not intended to limit the invention, but are instead intended to aid in the explanation and understanding of the various embodiments.

End user—A person desiring to access a network.

Public access network—A type of network allowing access to end users who are not the employees, students, members, etc. of the entity that owns the network. It should be appreciated that while most of the following descriptions of the embodiments make use of the public access network environment, the embodiments are also applicable to non-public networks.

Venue—The physical location where the public access network is located. Without limiting the generality of this term, examples would be airports, convention centers, coffee shops, restaurants, office buildings, etc.

Network provider—An entity who operates a network. Without limiting the generality of the foregoing, one example embodiment of this definition is where the entity operates a public access network. In this embodiment, the network provider desires to restrict access only to authorized end users.

Service provider—An entity with a direct business or other relationship with an end user. Without limiting the generality of the foregoing, one example embodiment of this definition is a company who sells service plans for public network access to end users. In this embodiment, the service provider has in its possession username, password, billing, and other data necessary to authenticate and authorize the end user to access public networks.

Business Support System—An internal system used by service providers to provision service for end users. This system contains, by way of non-limiting example, information necessary to authenticate and authorize end users for network access and use.

End user device—This can be any sort of electronic device. By way of example and not limitation, this could be a notebook computer, desktop computer, cellular phone, voice-over-IP phone, handheld computer, and etc.

End user unique device identifier (UDI)—In an IP-based network, all devices are required to have a unique identifier. By way of example and not limitation, possible UDIs include MAC addresses, SIM chips, software certificates, and any machine-readable identifier unique to a particular device.

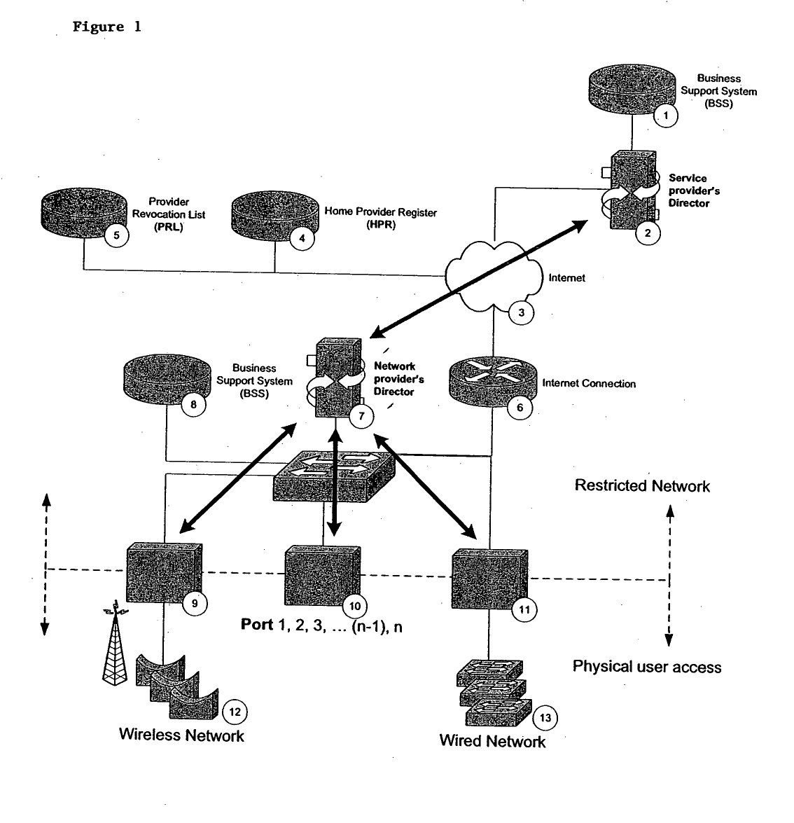

Home Provider Register (HPR)—In an embodiment, the HPR is a data set that relates an end user's device to their service provider(s). In one example embodiment, the HPR holds the username the end users uses for authentication, information on the end user's service provider(s), the end user's UDI, and a notation as to the type of device. In one embodiment, an end user may be represented by more than one entry in the HPR as noted by multiple UDIs. In the embodiment, no sensitive information, such as a password, is stored in the HPR, as the HPR is not intended as a data set for end user authentication credentials. In one embodiment, whether the end user has an All Access Pass as described below is stored in the HPR. The HPR, and its location on the network, is shown in FIG. 1.

Token—A piece of identification whose purpose is to relate the end user with his/her service provider(s). In an embodiment, the token takes the form of a cookie on a web browser. In an alternate embodiment, the token is hardware or software that is part of the end user's device and which contains a unique identification code. In one embodiment, the token indicates the existence of an All Access Pass as described below. In an alternate embodiment, a token represented by hardware or software on the end user's device is combined with information contained in the HPR to indicate the existence of an All Access Pass as described below.

Preferred service provider—In one embodiment, it cannot be assumed an end user already has a service provider. A service provider is necessary to gain access to the network provider's network. So an end user is not refused access to the public network, a network provider can specify one or more preferred service providers. In one embodiment, once it is determined the end user has no service provider (or no service provider appropriate for use on this public access network), the network provider offers the end user an opportunity to create a relationship with the preferred service provider. It is appreciated that the preferred service provider can be the network provider and/or another entity.

Network share—A situation where a network provider and a service provider have an agreement allowing the end user to make use of the public access network. In one embodiment, the end user creates no business relationship with the network provider. In another embodiment, the network provider and the service provider have no prior relationship and the network share is facilitated only for the duration of the end user's use of the public access network. In another embodiment, the network provider and the service provider have a pre-negotiated network sharing agreement governing the network share. The embodiments referenced in this definition are not mutually exclusive and can be happening (from the point of view of the network provider and the service provider) simultaneously when many different end users are making use of the public access networks.

RADIUS—Remote Authentication Dial In User Service utilized by legacy systems for determining an end user's service provider (RADIUS realm), authentication/authorization/accounting for end users, and by many 802.1x authenticators to communicate with authentication servers.

According to an embodiment, no matter where an end user decides to go, it appears to the end user(s) that they are only doing business with their service provider, when in fact they are actually making use of a separate network provider's network. It should be appreciated throughout that the network provider and the service provider may be the same entity.

An embodiment accomplishes this task with no new software or hardware requirements. The embodiment is independent from the type of network insofar as that network is based on, derived from, or similar to a TCP/IP network. Although the TCP/IP protocol suite is utilized in such an embodiment, it is appreciated that any network communication protocol with adequate abilities is equally applicable to the technology. By way of example and not limitation, the network may be based on Ethernet, optical, and/or wireless technology. An embodiment allows end-users to freely move between all networks and can operate in conjunction with seamless network-handoff (where an active session is transferred from one network medium to a different network medium while maintaining the session state; e.g., CDMA to 802.11b) systems since the embodiment is agnostic as to the network technology.

The business case why network providers, service providers, and end users would make use of the embodiments described herein is simple. As noted previously, end users desire to access internal and external networks from a wide variety of locations. Network providers undergo the significant capital costs of expanding network coverage by adding additional locations for public network access. To make the related capital investment worthwhile, network providers seek to attract large numbers of end users to make use of the public network access. Service providers have undertaken the significant capital costs of acquiring end users. To make the related capital investment worthwhile, service providers seek to make large numbers of locations offering public network access available for their end users.

One way to meet the needs of end users, service providers, and network providers is for network providers and service providers to pre-negotiate individual partnering (network sharing) contracts to allow end users to make use of various public network access locations. Because there are potentially so many network providers and service providers, such an approach is impractical. An embodiment facilitates end users' ability to access public networks even when the network provider and the service provider have no prior business relationship, reducing the need to rely on pre-negotiated network sharing contracts. A further embodiment offers advantages to the service provider and the network provider even when a prior business relationship (a non-limiting example being an individual partnering contract) does exist.

An embodiment allows service providers and network providers to control end-user access to public networks (even if owned by a different entity) via a distributed architecture easily scaling with the size of their network or the number of end users.

An embodiment allows even service providers with millions of end users to enable all of them to make use of public access networks simply by the implementation of the embodiment.

An embodiment facilitates use of agreements between network providers and service providers, including tracking usage for billing purposes. However, since most network providers and service providers have limited time to negotiate license agreements, an embodiment provides mechanisms for automatically creating dynamic network sharing agreements—even when the network provider and service provider have no prior business relationship.

An embodiment facilitates network sharing in a process completely transparent to the end user.

An embodiment facilitates network sharing in a process requiring no human intervention on the part of the network provider and/or the service provider except for the initial setup and occasional maintenance of certain settings.

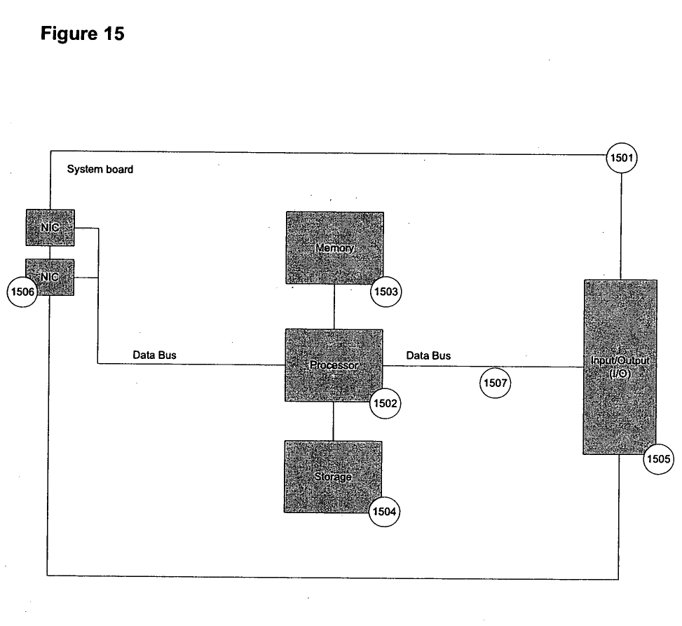

One embodiment is comprised of a Director component, a Port component, and a Home Provider Register (HPR). The HPR, defined above, is a service utilized by the embodiment for determining an end user's service provider. Each component is a software service that runs, in one embodiment, on uniform computing hardware able to connect to a data network. Uniform computing hardware refers to hardware necessary for a software operating system to function, in addition to network interface card(s) (NIC) for network connectivity. From this point on, uniform computing hardware will be referred to herein as a “computing appliance” and by way of example is shown in FIG. 15. Although a computing appliance is described in an example embodiment, it is appreciated that principles of the invention are equally applicable to any suitable device that can communicate over a network.

In FIG. 15, the computing appliance of an embodiment is comprised of a chassis (case) that supplies ample room for each hardware component, in addition to power and mounting locations for each component; including (but not limited to) a main-board (item 1501) with communications bus (item 1507) through which all components intercommunicate and connect to, processor chips (item 1502), memory (item 1503), data ports for input/output (item 1505), network interface cards (NIC) (item 1506) for network connectivity, hard drives for data storage (item 1504), ROM/Read/Write drives, power supply, etc. The diagram referred to is a visual example of a computing appliance. It is appreciated that components may be arranged or combined in any manner, and additional or fewer components may exist in embodiments.

In one embodiment, the Director and Port components can coexist on the same computing appliance. In another embodiment, the Director component exists on one computing appliance, and a Port component on another computing appliance. A fully functioning system of an embodiment includes one Director component. Because the technology is distributed (Director and Port components operate independently and communicate over a data network), many Director and Port components can be added as network scale and reliability are required.

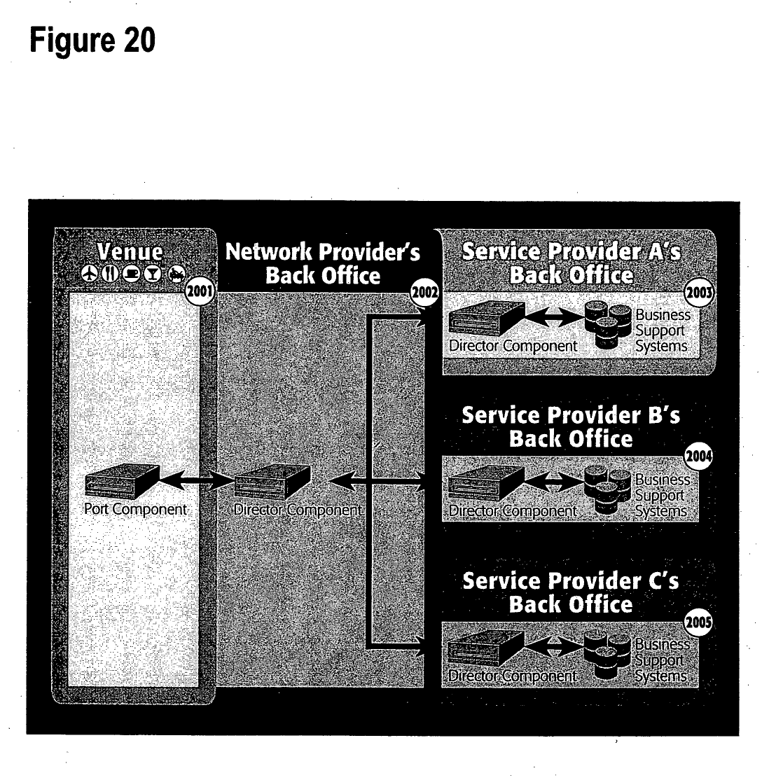

FIG. 20 illustrates where Port components and Director components can reside in one implementation of the embodiments. Item 2001 denotes a venue, as previously defined. A Port component resides in the venue and is connected to, and controlled by, a Director component in item 2002, located by way of non-limiting example in a network provider's back office. The Director component in item 2002 can communicate with one or many Director components operated by service providers as shown at items 2003-2005. The service provider Director components shown in items 2003-2005 are located by way of non-limiting example at the service providers' back offices and connected with their individual Business Support Systems (BSSs). Notice that in this embodiment, the BSSs do not communicate with one another.

In an embodiment, all component communication is encrypted and digitally signed to ensure the integrity and privacy of all network-transferred information. Each component has a digital certificate, which it uses to encrypt data before transmitting and to authenticate itself with other components.

Elements of the preceding discussion and of the subsequent discussion below are correspondingly illustrated in FIGS. 1, 20, 21, and 22. Each figure is a high-level network diagram in accordance with one embodiment.

Embodiments of the Port:

In an embodiment the Port component computing appliance is located in a network infrastructure such that one network interface is connected to the network where end users physically connect (e.g., wireless Access Points, Ethernet switch, etc.), and another network interface is connected to the restricted network where protected resources exist (e.g., Internet access, web/email/file servers, etc.). In another embodiment, only one network interface is connected to the restricted network segment if the Port component combines wireless radio functionality internally for end user's to connect to, by way of non-limiting example, an 802.11b access point. In another embodiment, the Port component is load-balanced across multiple computing appliances. Each Port component according to an embodiment enforces end-user access policy as defined and communicated by the Director component. All end-user restricted network resource requests are intercepted by the Port component (as all network packets go in one interface on the Port component and out another) to guarantee authenticated and authorized access to the resource; the Port component determines whether a resource request has an authenticated or non-authenticated user session state. Only in a user authenticated session state will network protocol level traffic be allowed, i.e., access to network resources over a data network.

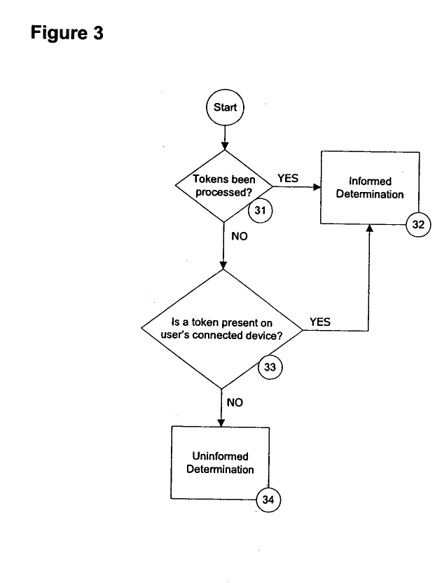

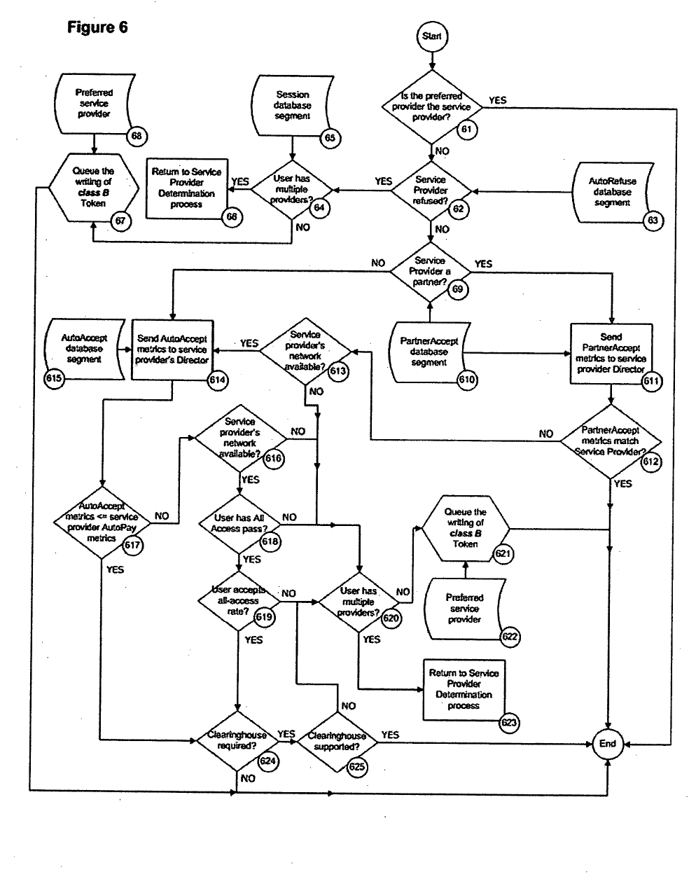

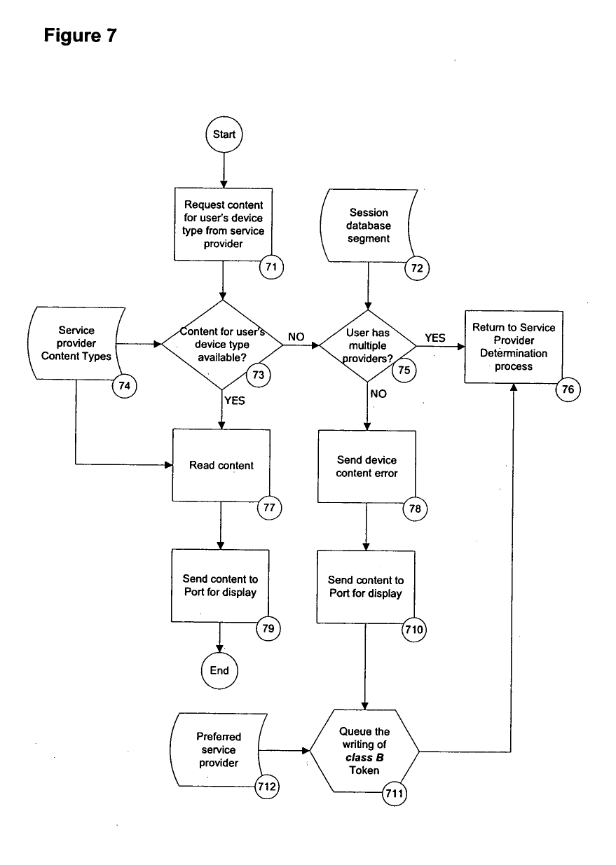

If an end user requests a restricted network resource, and has a non-authenticated user session state, their service provider is determined through a distributed searching process (Service Provider Determination process described below and illustrated in FIGS. 3, 4, and 5), and after a sharing agreement is reached between a network provider and a service provider (the Dynamic Network Share process described below and illustrated in FIG. 6) they are presented with their service provider's branded login page (Brand Import process described below and illustrated in FIG. 7) for display in a user graphical interface program (a web browser, as a non-limiting example) in accordance with the service provider's authentication mechanism (e.g., username/password, digital certificate, smart-card, etc.). If an end-user requests a restricted network resource and has an authenticated user session state, the request is routed to the resource. The Port component enforces security policy allowing network access to authenticated and authorized users only, keeping rogue users out.

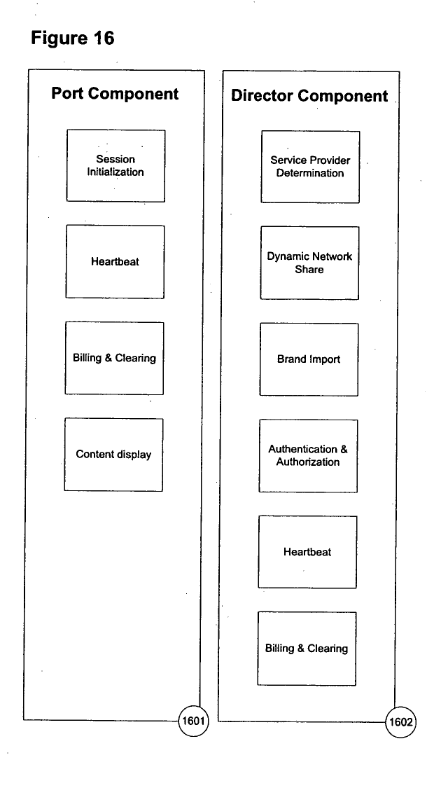

In an embodiment, processes that occur on the Port component (described in detail below) are illustrated in item 1601 of FIG. 16.

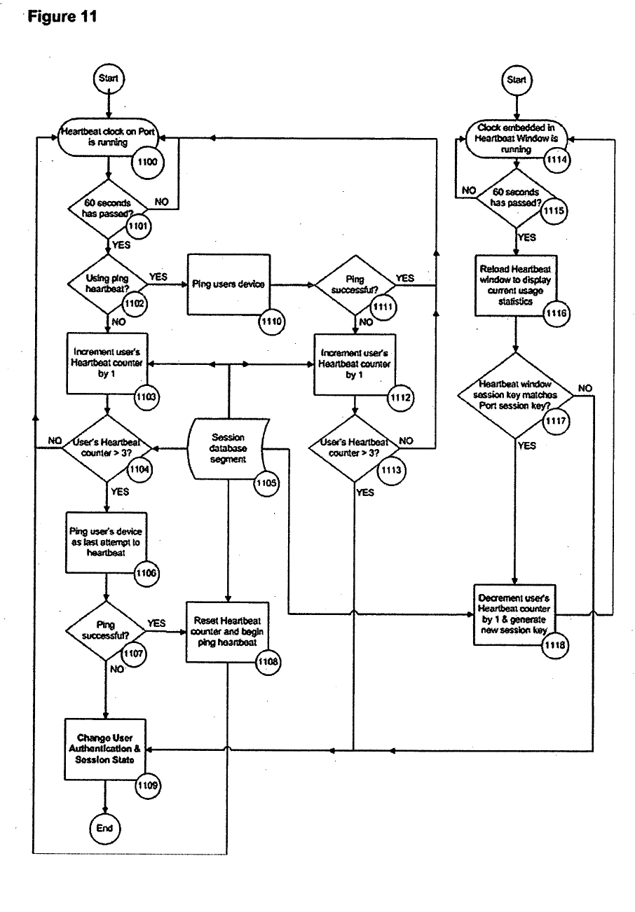

In addition to enforcing authentication and authorization of users attempting to access restricted network resources, the Port component of an embodiment tracks accounting data for each end-user during an authenticated user session state, and serves to shape (limit) bandwidth and apply quality of service (QoS) metrics according to the user's service plan as defined by his/her service provider. Other embodiments may include additional authorization metrics for enforcement, such as service level agreements (SLA), allowed network latency, etc. For accuracy and efficiency, the Port component, via a heartbeat process (the Heartbeat Process described below and illustrated in FIG. 11), monitors network activity for each authenticated end user. The heartbeat process ensures that an end user is still active on the network for accurate billing purposes, and that no unused authenticated user sessions are left open.

In an embodiment, Port component(s) are registered with the Director component, which ensures a Director component will not communicate with rogue, or unregistered Port components. In an embodiment, Port components are configured by their corresponding Director component, which enables centralized management of all components in the embodiment. As mentioned previously, in an embodiment communication between Port and Director components is authenticated and authorized via digital certificates. Communication between Port components and Director components and Business Support Systems is (by way of example) illustrated in FIG. 20.

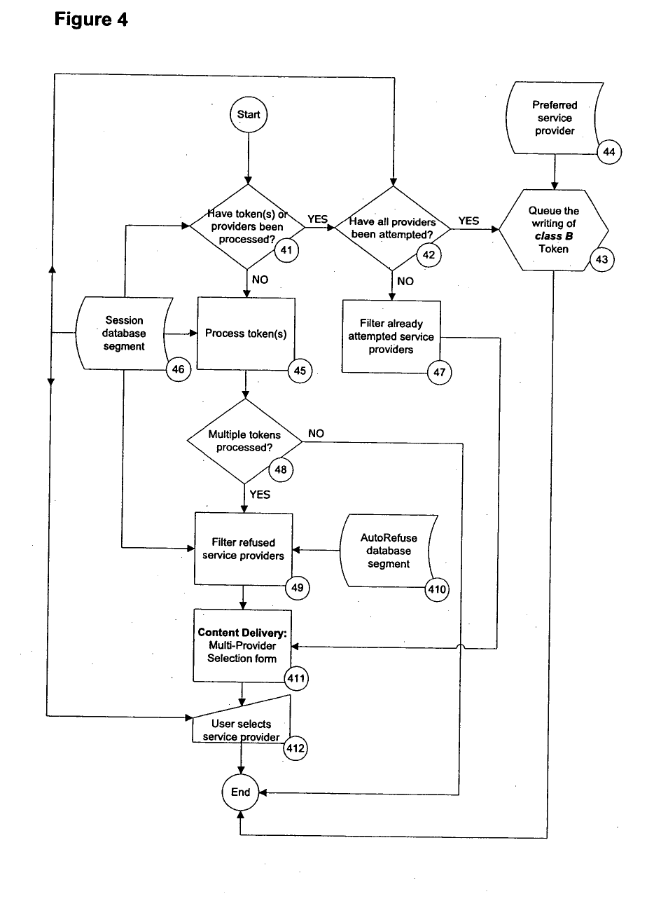

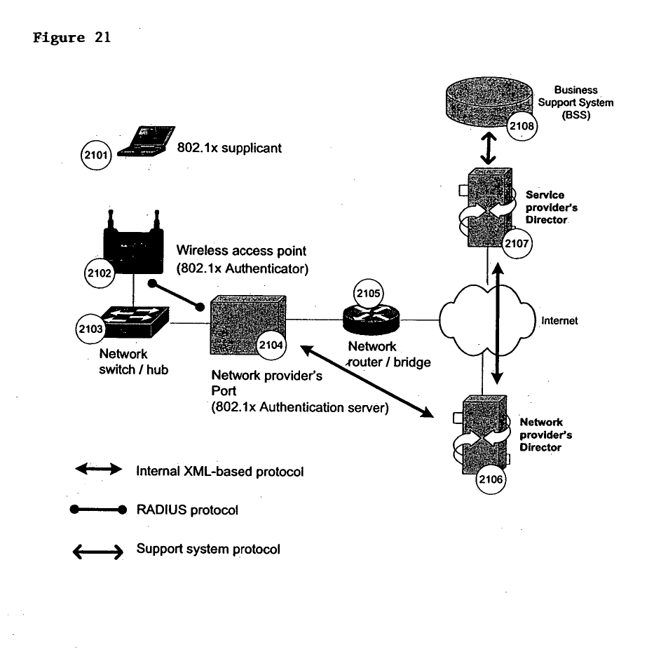

In an embodiment, (illustrated in FIG. 21) the Port component (item 2104) facilitates RADIUS server functionality in order to act as an authentication server for 802.1x authenticators (e.g., wireless access point) (item 2102). It is appreciated that different embodiments may expose additional protocol functionality to interact with different embodiments of authenticators, and RADIUS protocol functionality is described here by way of example. Information not limited to an end user's UDI is attainable within 802.1x protocol communication. Even though 802.1x communication occurs prior to IP address assignment, and the end user's device has not yet initiated a session with a Port component, the UDI and other pertinent data from 802.1x communication is used in an embodiment to automatically determine the end user's service provider as described by the Service Provider Determination process below and illustrated in FIGS. 3, 4, and/or 5. In one embodiment that supports 802.1x communication, the Brand Import process described in FIG. 7 is not required because 802.1x digital certificates contain information necessary to authenticate and authorize a user for network access and use. This embodiment enables transparent (no prompts for end-user input) access to public access networks that support 802.1x authentication, given that the end user's service provider supports 802.1x authentication. In another embodiment of 802.1x integration, the Brand Import process described in FIG. 7 is utilized in addition to 802.1x authentication. It is appreciated that 802.1x authentication support can be utilized in combination with many different embodiments.

Embodiments of the Director:

The Director component computing appliance of an embodiment is located on the restricted network, if not residing on the same computing appliance as the Port component. In another embodiment, a Director component may exist without a corresponding Port component, and is located on the network anywhere that remote network (Internet for example) access is available. In another embodiment, the services performed by the Director component may be load-balanced across several computing appliances. The Director component is able to communicate with Port components to update local user network and security metrics (access policy), and to send content for display by a Port component to an end user. Each Director component is also able to communicate with other Director components from other network providers (illustrated in FIG. 20), the Provider Revocation List (PRL)(discussed below), Business Support Systems, as well as with the Home Provider Register (HPR) when necessary. Communication with foreign Director components is performed in various embodiments to determine existing or create dynamic network sharing agreements, import login pages/brand and network requirement/restriction metrics for local enforcement, to apportion billing data, and other tasks; all of which involve an established business relationship. One familiar with the art can appreciate an embodiment involving the enforcement of certain business rules governing these business relationships.

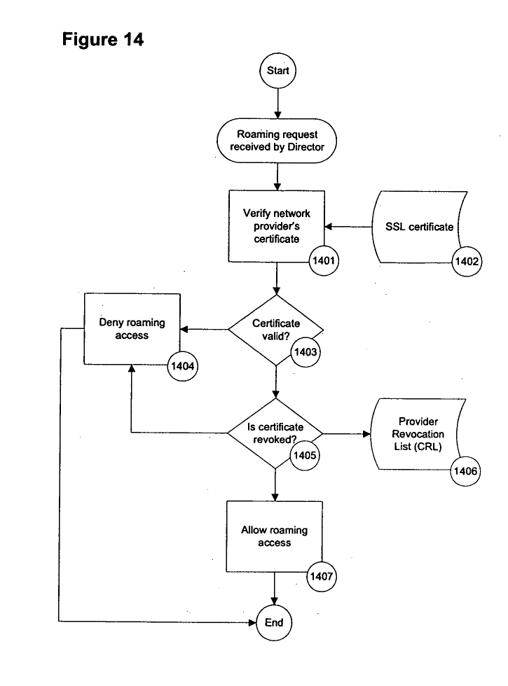

In an embodiment, when a Director component communicates with another Director component, the certificate of the requesting Director component is validated against the Provider Revocation List (PRL) by the receiving Director component, which resides in the network as illustrated in FIG. 1, and further detailed in FIG. 14. An embodiment utilizes this revocation list to render a part or parts of the embodiment that are unable to function to full capability (or at all). By way of example, if a service provider is refusing to remit payment for their end users' use of network providers' public access networks, an administrative party can add the specific service provider's Director component's certificate to the PRL. When the receiving Director component validates the certificate as revoked, the transaction will be halted, rendering the service provider's customer unable to access the network.

A related embodiment provides for a Director component's certificate to be revoked for violation of certain business rules. A further embodiment provides for the identity of the network provider or service provider whose certificate has been revoked to be added to the AutoRefuse database segment contained in each service provider and network provider's Director component. The AutoRefuse concept is discussed in connection with FIGS. 4, 5, and 6.

In one embodiment, all Director components are polled for the purposes of collecting certain usage metrics.

In another embodiment, all Director components are polled for purposes of populating the HPR. Data collected in the polling process is used to maintain the accuracy and completeness of the HPR.

Port components communicate end-user data (such as authentication information, usage metrics, etc) to the Director component over a secure channel in one embodiment. When a Director component receives end-user data from a Port component over various stages of an end user's session, at least some from the following non-exhaustive and non-limiting list of services are securely performed:

Determines the service provider of the end user

If applicable, determines the network-share agreement between the network provider and service provider (pre-existing or dynamically)

Imports the brand and appropriate login screen(s) of the service provider for Port component delivery to the end user

Communicates the end user's authentication credentials to the service provider

Communicates to the Port component whether to allow or deny network access to the end user and imposes any service provider restrictions and/or requirements such as bandwidth, QoS, service plan metrics, etc.

Communicates accounting information to the network provider (local) and service provider for billing purposes.

Communicates accounting information to a clearinghouse if specified.

In an embodiment, processes that occur on the Director component (described in detail below) are illustrated in item 1602 of FIG. 16.

FIG. 1 illustrates where an embodiment resides in the context of internal networks, external networks (such as the Internet), the service provider, the network provider, and the end user. Placement of Director components and Port components are described in further detail below. Specifically, in an embodiment there can be any number of Port components (items 9-11) within one or many venues. Each venue can employ multiple network technologies to connect end users to the network, wired and/or wireless (items 12 and 13). This example shows the network provider's Director component in the same venue as corresponding Port components, although it is appreciated that a Director component, whether a component of the network provider (item 7) or service provider (item 2), can be placed anywhere so long as the Port component can communicate with it across a network. Item 3 shows the Internet as an example network, but it is appreciated that any connecting network (public or private) is applicable.

In an embodiment, Director components communicate with business support systems (items 1 and 8) over a connected network. In an embodiment, the business support system resides on the same network as the Director component, but as mentioned previously, Director components can communicate over networked systems. Therefore, the business support system can be located on any reachable network not withstanding applicable business support system communication protocol and security restrictions. Embodiments support standard protocols used to communicate with business support systems.

In an embodiment, Director components communicate with a Provider Revocation List (PRL) (item 5) as described above and further detailed in FIG. 14, and with a Home Provider Register (HPR) (item 4). The PRL, like Director components, can be located on any reachable, connected network.

At least some of the elements and operations depicted in the various flowcharts, according to an embodiment, can be implemented in software or other machine-readable instruction stored on a machine-readable medium. Moreover, it is appreciated that the various operations in the flowcharts need not necessarily occur in the exact order shown, and that it is possible to add, remove, change, or combine some elements and operations.

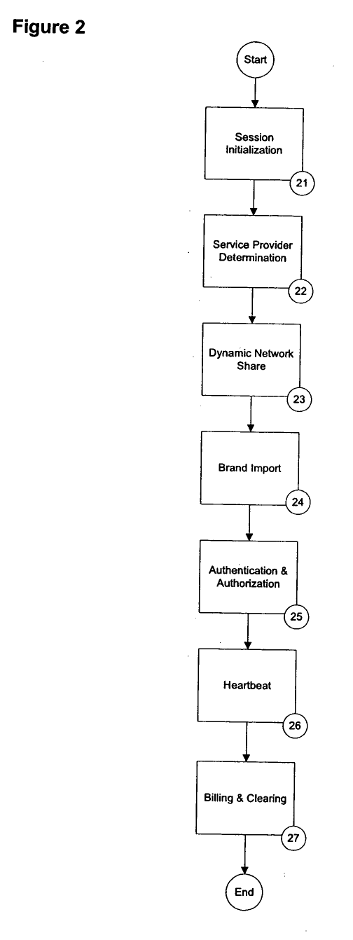

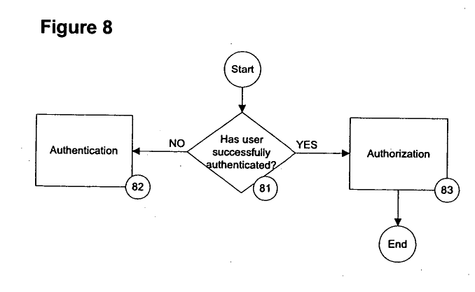

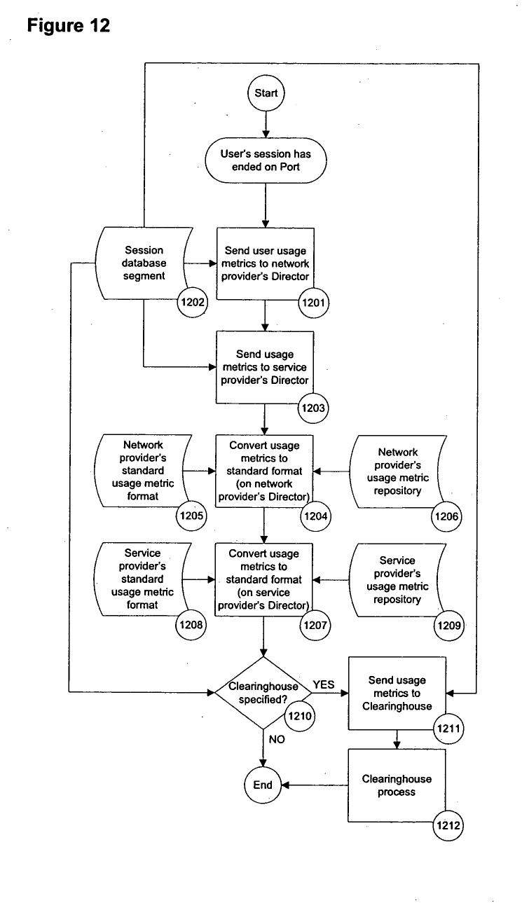

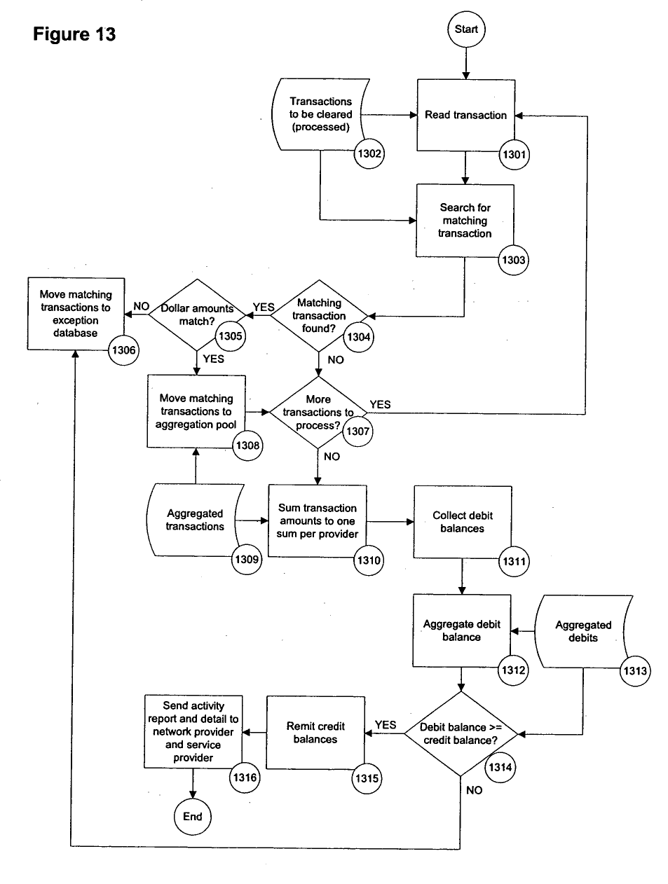

FIG. 2 is a top-level illustration of one embodiment. Item 21, session initialization, is the process by which an end user's session is created and prepared for use by components of an embodiment. This process occurs once for each time a unique device first requests access on a network where the embodiment is implemented, and involves gathering the device's UDI and token(s) if existing. The process begins when an end user attempts to access a restricted resource, such as an Internet web page, prior to being authorized by an embodiment. One embodiment steps through each of the processes noted in FIG. 2 and described in further detail elsewhere. The process is generally linear, but in certain situations noted below, an embodiment allows or requires movements up the process ladder represented in FIG. 2. Item 22 is covered in more detail on FIGS. 3-5. Item 23 is covered in more detail in FIG. 6. Item 24 is covered in more detail in FIG. 7. Item 25 is covered in more detail in FIGS. 8-10. Item 26 is described in more detail in FIG. 11. Item 27 is covered in more detail in FIGS. 12 and 13.

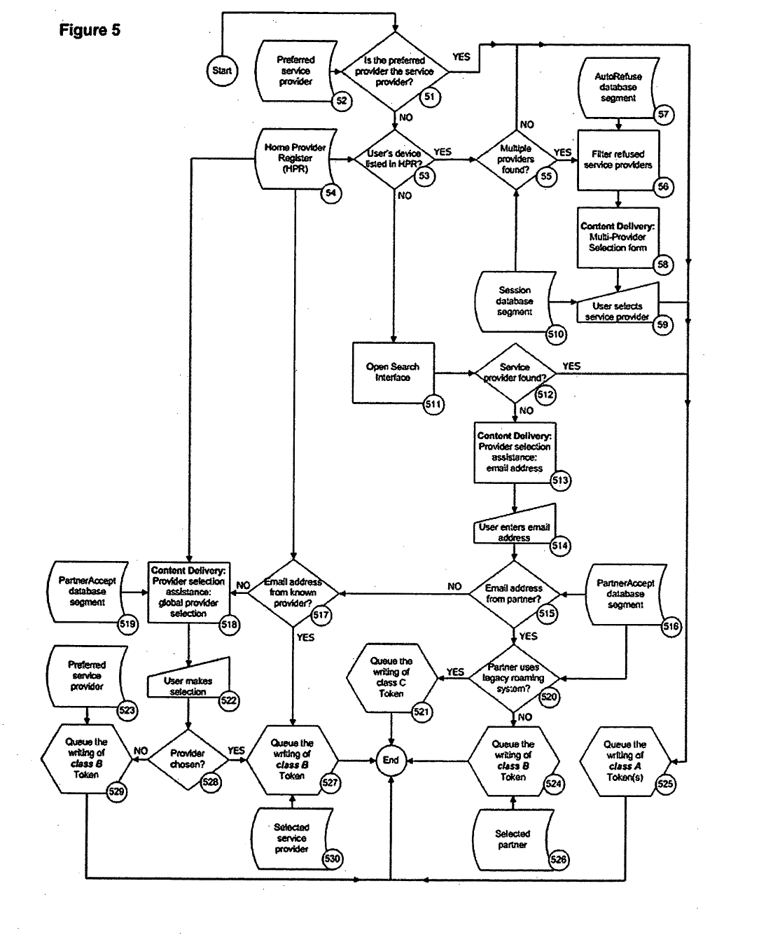

FIG. 3 is the first step in the embodiment where an end user's service provider is determined via several potential steps. Items 31 and 33 are used to ascertain whether a token is present on the end user's device. As noted above, tokens are one of the ways an embodiment determines the identity of the end user's service provider(s). Making this determination is the first step in facilitating a connection to the public access network. Item 32 occurs when tokens are found and are readable and is described in more detail in FIG. 4. Item 33 occurs when tokens are not found or are unreadable and is described in more detail in FIG. 5.

FIG. 4 illustrates the embodiment of a process that occurs when there are tokens present on the end user's device. In one embodiment, complications are introduced by the possibility the end user may have more than one service provider. In item 41, an initial check is made to determine whether the token(s) present on the end user's device have already been processed. This is necessary because the process illustrated in FIG. 4 may be returned to in the middle of later processes. If the tokens have not been processed, they are processed in item 45. In one embodiment, when the tokens are processed they are entered into the memory of the Port component. This is noted in item 46 as the session database segment.

If there are multiple tokens discovered in item 48, the end user is prompted with a menu at item 411 to choose one of the potential service providers specified in the tokens at item 412. Before the list is presented to the end user, one embodiment filters out any service providers in the network provider's AutoRefuse database (item 410) as noted in item 49.

If the overall process (from any point illustrated in FIGS. 3, 4, and 5) returns to the Informed process described in FIG. 4 with the tokens already processed, at item 42 a search is made to see if multiple providers (as indicated by multiple tokens) have all been tried. If the search at item 42 shows one or more providers who have not been attempted, the previously attempted providers are filtered out at item 47 and shown in a list to the end user at item 411, whereupon the end user makes a choice as to what provider to try next at item 412, ending the process described in FIG. 4.

One embodiment facilitates the creation of a dynamic network sharing relationship between a network provider and service provider. Because there is a good chance the network provider and service provider have had no prior business relationship, good business practices require the ability of either provider to specify certain organizations they refuse to do business with. Such organizations are listed in the network provider and service provider's AutoRefuse database segment and are therefore prohibited from participating in any network sharing arrangement.

One embodiment is to ensure any end user that desires access to the network provider's public access network is able to get access. In certain situations described below, the process returns to item 41. If, at item 41, it is determined all the tokens have been processed and, at item 42, all the service providers designated in those tokens have been attempted, the embodiment falls over to a preferred service provider as defined above. In item 43, the concept of multiple types of tokens (in this case, a class ‘B’ token) is introduced. In one embodiment, multiple classes of tokens are necessary for smooth operation. In general, class ‘B’ tokens denote a need for further verification that the end user actually has a relationship with the chosen service provider. In item 43, a class ‘B’ token is scheduled for writing using the preferred service provider information noted at item 44 and the process described in FIG. 4 ends.

Once the service provider is determined, the process moves on to the next step, illustrated in FIG. 6.

As noted previously in the description for FIG. 3, there is a possibility no tokens are present on the end user's device, described as an uninformed decision. By way of example and not limitation, this could be because the tokens were purged, lost, or never initialized (the last as with an end user brand new to a service provider). If a token(s) is not available at the beginning of FIG. 3, the process illustrated in FIG. 5 becomes operational.

Item 51 checks to see if the end user's UDI is registered with the network provider's preferred provider via item 52. It is appreciated here the network provider could be their own preferred provider or the network provider could contract that responsibility out to another organization. In the former instance, the search for the end user's UDI would happen on the network provider's Director component of the embodiment (such component described above). In the latter instance, the search for the end user's UDI would happen on the contracted preferred service provider's Director component of the embodiment. If the UDI is found in this manner, a class ‘A’ token is scheduled for writing as shown in item 525. A class ‘A’ token signifies a verified relationship between the end user and the chosen service provider.

If the end user's UDI is not registered with the preferred provider, a search is made in the HPR at item 53, accessing the HPR data at item 54. If multiple service providers are listed in the HPR at item 55, the service providers are filtered at item 56 through the network provider's AutoRefuse list from item 57, presented to the end user at item 58, and selected by the end user at item 59. Once a provider is chosen at item 59, at item 525 a class ‘A’ token representing the chose service provider is scheduled for writing.

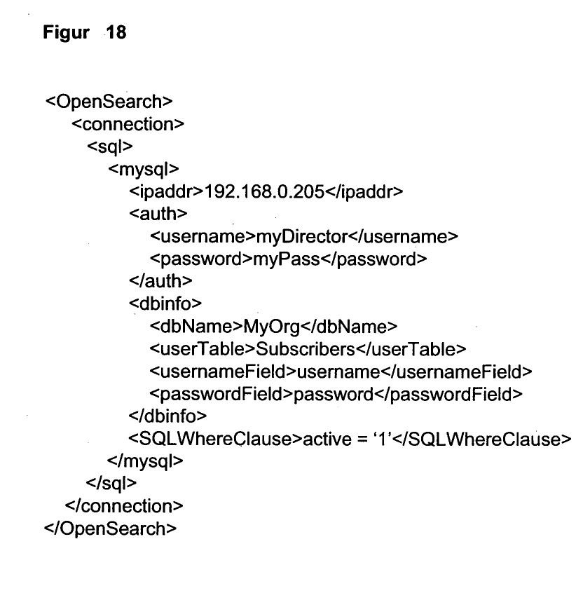

If the end user's UDI is not found in the HPR at item 53, one embodiment employs an open search interface at item 511. One embodiment of the open search interface employs an XML (Extensible Markup Language) extension language utilized by network providers and service providers to connect non-standards based customer authentication systems. By way of example, a potential XML document that describes connecting to a SQL (Structured Query Language) authentication system is shown in FIG. 18. It should be appreciated that there are any number of other XML-based extensions that describe how to connect to different types of authentication repositories. Another embodiment of the open search interface examines UDI data on Director components of service providers who are known to have relationships with the network provider. Another embodiment of the open search interface examines UDI data on Director components of service providers according to geographic-based rules. Another embodiment of the open search interface examines UDI data on Director components of service providers who have large numbers of end users. It should be appreciated there are other potential search parameters for examining UDI data on Director components of service providers.

At item 512, if no service provider is found via the process described in FIG. 18, one embodiment at item 513 prompts the end user to enter his or her e-mail address associated with the company suspected to be the service provider at item 514. Several checks are made using this information. In item 515, the process makes use of one embodiment that is a list of the network provider's pre-negotiated network sharing partners as described above. These pre-negotiated network sharing partners are contained in a database specified as the PartnerAccept database in item 516.

One embodiment has both the network provider and the service provider using embodiments described herein. An alternate embodiment allows for a network provider using the technology to partner with a service provider who is using a legacy roaming system. By way of example and not limitation, a legacy roaming system could be a system limited to using an implementation of the RADIUS realm architecture. This alternate embodiment knows how to communicate with the legacy roaming system (RADIUS protocol) to determine whether the system is indeed the service provider for this end user. It should be appreciated that an embodiment can handle the simultaneous situation of a service provider and network provider both using implementations of the invention, and the alternate situation of a network provider using an implementation of the invention and the service provider using a legacy roaming system. If the end user is found on the legacy roaming system at item 520 using information found at item 516, a class ‘C’ token is queued for writing as noted in item 521. It should be appreciated that while FIG. 5 does not suggest end user input might be required to determine whether the end user has a relationship with a service provider using a legacy roaming system, end user input may be required.

If the e-mail address is from a partner who has implemented the embodiment, a class ‘B’ token is queued for writing at item 524 using information from item 526 and the process described in FIG. 5 is exited.

If the e-mail address provided by the end user in item 514 is not on the network provider's PartnerAccept list, the input is scanned at item 517 using a segment of the HPR at item 54 to determine if the service provider indicated by the e-mail address has an implementation of the invention. If so, a class ‘B’ token is written at item 527 using information at item 530 and the process described by FIG. 5 is exited. If not, a list of all service providers with implementations of the invention is provided at item 518 from the HPR at item 54 and the service providers listed in the PartnerAccept database segment at item 519 for the end user to choose at item 522. At item 528, if the end user chooses a provider from the list, a class ‘B’ token is written at item 527 from information at 530 and the process described by FIG. 5 ends. If the end user does not choose a provider at item 522, item 528 directs the writing of a class ‘B’ token at item 529 from the preferred provider list at item 523 and the process described in FIG. 5 ends.

Once the service provider is determined, the process moves on to the next step, illustrated in FIG. 6.

FIG. 6 illustrates the embodiment where a network share is initiated between the network provider who owns the public access network and the end user's determined service provider. As described above, an embodiment provides for a potential network share regardless of whether the network provider and the service provider have ever had a prior business relationship.

In item 61, if the service provider is the preferred provider, a network share is presumed to be in place and the process described in FIG. 6 ends. As noted above, the preferred provider is either the network provider or an organization specified by the network provider.

If not, the process moves to item 62. If the service provider is in the AutoRefuse database segment at item 63, a check is made in item 64 of the session database at item 65 to see if this end user has tokens representing multiple service providers (and they chose one of them prior to this process). If so, the process returns at item 66 to the Service Provider Determination Process illustrated in FIG. 3. If the end user does not have tokens representing multiple providers, then the process schedules the writing of a class ‘B’ token at item 67 using information at item 68 (the preferred service provider) and the process described in FIG. 6 ends.

At item 62, it is determined if the end user's service provider is refused by the network provider. In addition to utilizing the AutoRefuse database segment (item 63), the Provider Revocation List (PRL), as described above, is also consulted in an embodiment. Prior to transmitting any data, Director components of an embodiment use their digital certificate (as described above) to authenticate with other components of the system and to encrypt the data stream. At item 1401 in FIG. 14, the service provider's Director component receives data from the network provider's Director component and verifies the integrity of the digital certificate (illustrated by item 1402) at item 1403. If the digital certificate is not valid, further communication with the sending Director component during this session is denied (item 1404) and the process ends. If the digital certificate is valid, it is further verified against the PRL (item 1406) (location in the network illustrated in FIG. 1) at item 1405. If the digital certificate is rejected by the PRL, further communication with the sending Director component during this session is denied (item 1404). If the digital certificate is not rejected by the PRL, further communication with the sending Director component is allowed and the session continues as normal.

If the service provider is not refused in item 62, the identity of the service provider is compared at item 69 to the network's providers PartnerAccept list of pre-negotiated network sharing partners (item 610). In one embodiment, the PartnerAccept database segment contains the name of the service provider as well as certain financial and service metrics specified in the partnership. These metrics are packaged by the network provider's Director component and sent to the service provider's Director component at item 611. The metrics are compared with those stored in the PartnerAccept database segment on the service provider's Director at item 612 to make sure a partnership indeed exists and the metrics are identical. If so, the process moves on to the next step, illustrated in FIG. 7. It should be appreciated there are many metrics that could be involved in the comparison of the PartnerAccept databases, including by way of example and not limitation the requirement for the use of the Clearinghouse process as described below. An alternate embodiment allows the network provider to only agree to implement a network share with those service providers in its PartnerAccept data set.

If the PartnerAccept metrics for the service provider and network provider do not match at item 612, item 613 denotes a check to make sure the service provider's Director component is available. If it is not, the process moves to items 620-623. At item 620, it is determined whether the end user has multiple providers. If not, a class ‘B’ token is scheduled for writing at item 621 from information at item 622 (preferred service provider) and the process described by FIG. 6 ends. If multiple providers are discovered at item 620, at item 623 the process is returned to the process described in FIG. 3, as a new potential service provider is to be chosen. It should be appreciated the service provider's Director component also contains the service provider's AutoRefuse database list which function exactly the same as the network provider's AutoRefuse database list as described above.

If the result at item 613 shows the service provider's Director component is available, the network provider's Director component communicates AutoAccept metrics from item 615 to the service provider's Director component at item 614. To facilitate a network share when no pre-negotiated agreement exists, the embodiment must protect the business interests of both the network provider and the service provider. The network provider determines the minimum it will charge for the use of its public access network and enters this in the AutoAccept database segment located on its Director component (i.e., the minimum payment amount accepted for use of the provider's public access network). The service provider determines the maximum it will pay to allow one of the service provider's end users to use the network provider's public access network. The service provider enters this into the AutoPay database segment located on its Director component. Such metrics are entered during the configuration of the Director component. Facilitating network sharing agreements based on these metrics is automatic and does not require human intervention. By way of example and not limitation, the metrics entered into the AutoAccept and AutoPay database segments can be based upon charged per minute and/or per byte transferred, and can be staged according to quality of service metrics. It should be appreciated that as the industry matures and new service plans are created, one embodiment allows for great flexibility in the kinds of metrics that can be entered into the AutoAccept and AutoPay database segments.

In item 617, the service provider's Director component compares the metrics. If the AutoAccept metrics specified by the network provider are less than (or equal to) the AutoPay metrics specified by the service provider, a network share is deemed possible (i.e., the service provider is willing to pay what the network provider requires for use of its public access network). A check is then made at item 624 to determine if either the network provider or the service provider requires the use of the Clearinghouse process (described below). Provided a match again occurs here, a network share is initialized for the duration of the end user's session and the process described in FIG. 6 ends. It should be appreciated the embodiment allows for both the network provider and the service provider to have multiple network share arrangements operational at any one time, all potentially with different parties and utilizing different PartnerAccept, AutoAccept, and AutoPay metrics.

If, at item 617, the AutoAccept metrics are greater than the AutoPay metrics, then a check is made at item 616 to see if the service provider's network is available. If not, the process noted by items 620-623 as described above occurs. If the check that occurs at item 616 shows the service provider is available, the process moves to item 618.

In item 618, the concept of the All Access Pass is introduced. As noted above, end users desire easy, ubiquitous access to networks. One embodiment allows service providers to offer end users an All Access Pass. While the normal business of the service provider may require limitations on the metrics represented in the AutoPay metrics, the All Access Pass allows the end user the opportunity to circumvent the AutoPay parameters by agreeing to bear the AutoAccept metrics specified by the network provider. The relationship between the end user and the service provider remains intact and the network provider's network share arrangement continues to be with the service provider. It should be appreciated that while an end user with All Access Pass capabilities can override the service provider's AutoPay provisions by agreeing to bear the financial responsibility, the All Access Pass does not take precedence over an AutoRefuse designation at the service provider's Director component. At item 619, the end user is asked to accept or reject the rates provided by the network provider. If the rates are accepted, checks at item 624-625 are performed for the necessity of the Clearinghouse. If there is compatibility in Clearinghouse (described below) requirements between the network provider and the service provider, the process described in FIG. 6 ends. If not, the process at items 620-623 described above occurs. If, at item 619, the end user does not accept the All Access Pass costs provided by the network provider, the process at items 620-623 described above occur.

In item 69, if the service provider is not listed in the PartnerAccept database in the network provider's Director component, the process proceeds directly to the process beginning at item 614 described above.

Once the network share is implemented, the process moves on to the next step, illustrated in FIG. 7.

As noted above, service providers expend considerable capital resources to obtain, retain, and maintain end users. It should be recognized most service providers are protective of their brands and want their end users to see only their brand. Put another way, service providers wish to avoid brand leakage. FIG. 7 illustrates one embodiment where the service provider's brand (content) is imported for viewing by the end user. The effect is to make it seem as if the end user is actually on the service provider's own network. It should be appreciated that one embodiment allows the network provider to use greeting screens containing its brand. By way of example and not limitation, this is very common in locations such as airports and other public venues. This in no way limits or circumvents this portion of the process.

The operations noted in FIG. 7 should be readily apparent to someone familiar with the art having the benefit of this disclosure. The end user may see several different types of content depending on the situation. By way of example and not limitation, if the network provider and the service provider are different organizations, one embodiment means the end user may see content that denotes they are roaming. By way of example and not limitation, one embodiment could cause geographically specific information to be returned.

The request in item 71 is made from the network provider's Director component once the process illustrated in FIG. 6 is complete. The content search denoted by item 73 and the read operation denoted by item 77 happens on the service provider's Director component and are informed by the data in item 74. The data in item 74 denotes a data set that describes different types of devices and the content (or location of the content) that should be used for the end user's device for this session. The information is then sent to the network provider's Director component and routed to the network provider's Port component housed at the public access network location at item 79.

If no content is found at item 73 (e.g., there is no content available for the end user's device type), it is determined whether or not there are multiple providers at item 75 as informed by item 72. If so, at item 76 the process returns to the process described in FIG. 3. If not, error information is returned at item 78 and displayed at item 710. A class ‘B’ token is scheduled for writing at item 711 for the preferred service provider provided specified by item 712, and the process returns at item 76 to the process described in FIG. 3.

Once the brand is imported, the process moves on to the next step, illustrated in FIG. 8.

The embodiment illustrated in FIG. 8 makes it clear an end user must be both authenticated and authorized for him/her to begin using the public access network.

Authentication is the process whereby the end user's relationship with the service provider is confirmed through the exchange of login metrics. It should be appreciated this embodiment can make use of, by way of example and not limitation, user-entered username and password authentications, certificate-based authentications, 802.1x client authentications, and hardware authentications. It is appreciated that any credentials and/or metrics used for authentication purposes are applicable.

Authorization is the process whereby the service provider determines whether a previously authenticated user has privileges necessary to access the requested resource. By way of a non-limiting example, if the authenticated end user is accessing an Internet web page from a network located in Arizona, and the authenticated user has a limited access plan for the state of Washington that does not support roaming, he/she would not be authorized to access the web page due to the roaming restriction. Embodiments allow the service provider to implement authorization metrics that include, by way of example and not limitation, geographic, roaming, time-based, bit-based, and other rules.

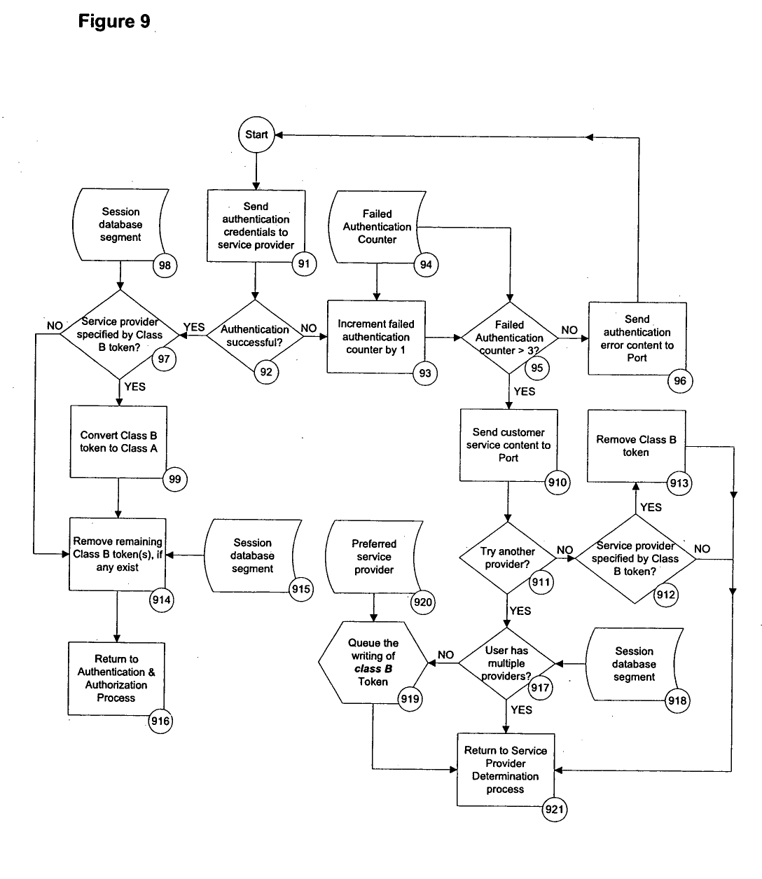

If the end user is not determined to be authenticated at item 81, then the authentication process is started at item 82. The embodiment covering the authentication process at item 82 is illustrated by FIG. 9.

As noted before, an embodiment allows for different classes of tokens. A class ‘A’ token is presumed to represent a validated relationship between the end user and a service provider. A class ‘C’ token represents a relationship between an end user and a service provider using a legacy roaming system. A class ‘B’ token represents a suspected, but as-yet-unvalidated relationship between an end user and a service provider.

At item 91, authentication credentials are sent to the service provider. When an end user successfully authenticates in item 92, if the relationship between this end user and this service provider was represented by a class ‘B’ token at item 97, that token now becomes a class ‘A’ token at item 99 (as the relationship between the end user and the service provider is now verified) and any remaining class ‘B’ tokens collected during the session (shown via item 915) are deleted at item 914 (as all un-verified relationships that may have been created in previous processes are no longer required for further processing). If, at item 97, the service provider was described by anything other than a class ‘B’ token, all class ‘B’ tokens shown at item 915 are deleted at item 914. The process described in FIG. 9 ends at item 916, moving back to the process described in FIG. 8 for authorization processing.

On the other hand, if an end user does not successfully authenticate at item 92, a counter is initiated at item 93 and held in item 94. The counter is analyzed at item 95, where it should be appreciated by someone familiar with the art the number 3 indicated at item 95 is a non-limiting example of the number of times authentication errors are tolerated. If the check at item 95 is three or less, error content is sent to the Port for display to the end user at item 96 and the process restarts (e.g., the end user is prompted to re-enter their authentication credentials).

If, at item 95, the counter is greater than three, customer service content is sent to the Port for display to the end user at item 910. Customer service information is data (for example) such as a customer support telephone number. This information is entered into the Director component during initial configuration. At item 911, the end user is asked if he/she would like to try another provider. If the user declines, a token check is performed at item 912. If the token was a class ‘B’ token, the class ‘B’ token is removed at item 913 and the process is returned to the process described in FIG. 3 at item 921. If the token was not a class ‘B’ token, the process is returned to the process described in FIG. 3 at item 921. If, at item 911, the end user agrees to try other providers, a check to see if the user has multiple providers is performed at item 917 via information at item 918. If there are multiple providers, the process in FIG. 9 ends and the process shown in FIG. 3 is started at item 921. If there are not multiple providers, a class ‘B’ token is written at item 919 for the preferred provider from item 920, and the process is returned to the process shown in FIG. 3 at item 921.

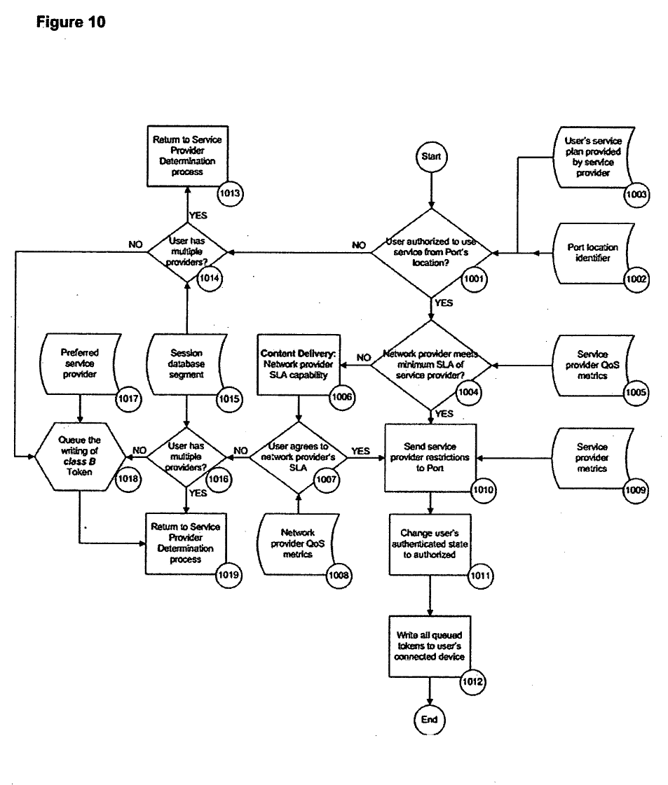

Once the user is authenticated, the process moves back to FIG. 8. At item 81, the end user is seen as authenticated and moves to item 83, illustrated by FIG. 10.

An embodiment allows the service provider to enforce service plan metrics by the authorization steps illustrated in FIG. 10. It is important to understand items 1001-1003 are, by way of example and not limitation, potential authorization parameters a service provider can implement.

Items 1001-1003 rely on an embodiment that is sensitive to the geographic location of the public access networks. As described in more detail below, in this embodiment the network provider's Director component has the ability to specify the geographic location of each Port component. This information is entered when a Port is configured and registered with a Director component as described above. In item 1001, this authorization process is checking via information gained from items 1002 and 1003 to make certain the service provider has allowed the end user to use public access networks in the geographical area where the Port component is located. One familiar with the art will appreciate that data in item 1003 is obtained during the authentication process illustrated in FIG. 9, and is obtained from connected Business Support System(s). The Port component's location identifier (described in item 1002) is obtained from the network provider's Director component when authentication credentials are communicated to the service provider's Director component.

If, at item 1001, the user is authorized to access service from the Port component's location, the process moves to item 1004. Items 1004-1008 rely on an embodiment allowing the service provider to withhold authorization if certain usage metrics (by way of example and not limitation, upload and download speeds on a broadband network) are not met. The end user and service provider cooperate in making sure the authorization process can be abandoned if the network provider's network is unable to maintain certain levels of service. Quality of Service (QoS) metrics can be manually specified in the network provider's Director component and/or automatically generated based on real-time network performance. At item 1004, QoS metrics are gathered from item 1005 and compared (i.e., the service provider configures a minimum QoS requirement that must be met by a network provider if the service provider's end user is to utilize the network). If a network provider cannot meet the QoS requirements specified by the service provider's Director component, the end user will be prompted for further action (i.e., if they want to continue to use the network provider's public access network even though it does not perform to levels the service provider deems adequate). If the QoS requirements are not met, the process moves to item 1006 where content is delivered to the end user in item 1007. If the end user agrees to continue despite the mismatch shown in the information provided in item 1008 (as described above), the process moves to item 1010. At item 1010, any service provider restrictions on this end user as specified at item 1009 are sent to the Port, where they are enforced. By way of example, if the service provider specifies that an end user has only ten minutes and 100 Mbytes remaining on his or her service plan, and should only have 256 Kbps of throughput, the Port component will enforce each of these requirements. When any hard limits are met (number of available minutes for example), the end user's session state will be changed to unauthenticated. It is appreciated that a Director component can be configured to either “hard” end a session when a limit is reached by changing the authentication state to unauthenticated, or “soft” end the session, where the state remains authenticated until the end user logs off or ceases using the session. This allows for a non-abrupt interruption of service. At item 1011, the end user's state is changed to “authenticated,” all tokens previously queued in prior processes are written at item 1012, and the process described in FIG. 10 is ended.

At item 1008, if the end user does not agree to accept the QoS metrics, a check is made at item 1016 if there are multiple providers. If so, at item 1019 the process returns to the process described in FIG. 3. If there are not multiple providers at item 1016, then a class ‘B’ token is scheduled for writing at item 1018 for the preferred service provider specified in item 1017, and at item 1019 the process returns to the process described in FIG. 3.

If, at item 1001, the end user is not authorized to use the service from the Port component at this location, then a check is made at item 1014 via information at item 1013 to see if there are multiple providers. If so, at item 1013 the process returns to the process described in FIG. 3. If not, then a class ‘B’ token is scheduled for writing at item 1018 for the preferred service provider provided in item 1017, and at item 1019 the process returns to the process described in FIG. 3.

Item 1009 is a simple representation of other metrics that an embodiment may use to control the end user's experience even when the end user is accessing a public access network owned by someone other than the service provider.

The information represented by items 1003, 1005, and 1009 come from the service provider's business support system and is retrieved from that system by the service provider's Director component. More details on this appear below.

Item 1010 denotes the sending of the collected authorization metrics from the service provider's Director component to the network provider's Port component via the network provider's Director component (see FIG. 20 for Director-Port component communication). All tokens scheduled to be written in previous processes are written to the end user's device at this point, illustrated in item 1012.

Once the user is authorized and authenticated, the process moves on to the next step as illustrated by FIG. 11.

For security and accurate billing purposes, it is important to know which end-user devices are active and which are not. If an end user does not properly log off, the system must detect this and remove any unused sessions and cease accounting for the end user's use of the network. The embodiment illustrated in FIG. 11 is the process where by an end user's device is verified to be active on the network. It is appreciated that explicitly defined time limits or counters shown in FIG. 11 are examples and may be any appropriate value in other embodiments. In an embodiment, when a device is determined to be not active, the length of time it took to determine this is credited to the end user's session.

At item 1110, it is noted the Heartbeat clock is running. This clock represents the cycle between heartbeats (i.e., an attempt to verify if a device is active on the network). A check is performed at item 1101 to see if 60 seconds has passed, if not, the process cycles back to 1110. If so, it is determined in item 1102 if the ping method for the Heartbeat is being used. In one embodiment, the heartbeat is a small pop-up window in the end user's browser. With the advent of pop-up blockers, such technology is no longer reliable. Items 1110-1113 represent a substitution of network pings (ICMP type 8 echo request) as the heartbeat. If the ping method is being used, the end user's device is pinged at item 1110. At item 1111, a successful ping returns the process to item 1100. At item 1111, an unsuccessful ping increments the Heartbeat counter by 1 at item 1112 using the data contained at item 1105. The Heartbeat counter is analyzed at item 1113, and if it is three or under, the process returns to item 1110. If the Heartbeat counter is over three, the process moves to item 1109 where the end user's authentication and session state is changed. The process is then ended.

At item 1102, if the ping heartbeat method is not being used, the Heartbeat counter is incremented by one at item 1103 and tracked at item 1105. Next, the Heartbeat is analyzed at item 1104 using information from item 1105. If this analysis shows the Heartbeat to be three or under, the process is returned to item 1110. If this analysis shows the Heartbeat to be over three, the end user's devices is pinged at item 1106 in a last effort to determine whether it is still accessing the public access network. If, at item 1107, the ping is successful, at item 1108 the Heartbeat is reset in the data contained at item 1105 and the process returns to item 1110. If, at item 1107, the ping is not successful, the end user's authentication and session state are changed to “unauthenticated” at item 1109 and the process ends.

At items 1114-1118, a process parallel to that described in items 1100-1113 described above occurs. At item 1114, a clock embedded in the Heartbeat window (a small web browser window, as a non-limiting example) is running. In one embodiment, this window shows usages statistics. At item 1115, a check is performed to see if 60 seconds have passed. If not, the process returns to item 1114. If so, at item 1116 the Heartbeat window is reloaded with current usage statistics. Once this occurs, at item 1117 a check is made to make sure the Heartbeat window session key matches the Port session key. If a match does not exist, the end user's state and authentication at item is changed at item 1109 and the process ends. If there is a match at item 1117, the Heartbeat counter is decremented by one and a new process key is generated at item 1118. The process by which the heartbeat window reloads (HTML Meta Refresh by way of a non-limiting example), enables the Heartbeat counter to be decremented on the Port component. Both processes in FIG. 11 run in parallel, one incrementing the heartbeat counter, the other decrementing the heartbeat counter. In the embodiment where ICMP type 8 packets are used, the heartbeat window will not be active and will hence be ignored, as it's function is unused. One familiar with the art will appreciate that an embodiment of the process described in FIG. 11 is automatic and requires no human intervention.

An additional embodiment monitors traffic activity through the Port component as a substitute or supplement for the heartbeat/ping procedure, as this method is passive and takes into account the device may be configured to ignore ICMP type 8 packets. Furthermore, this embodiment does not utilize network bandwidth.

This heartbeat process continues until it is determined the end user has finished his/her use of the network provider's public access network. The end user's session state is changed at item 1109 and the process ends, moving to the process described in FIG. 12.

The embodiment shown in FIG. 12 is an illustration of the billing process that happens after the end user's session is complete. The billing amounts are governed by the PartnerAccept, preferred service provider, and/or AutoAccept/AutoPay relationships embedded in the Dynamic Network Share process illustrated in FIG. 6.

At item 1201, the usage metrics collected during the end user's active session and represented here by item 1202 are sent to the network provider's Director component. At item 1203, the same information is sent to the service provider's Director component.

At item 1204, the standard usage metrics sent to the network provider are converted to the format specified at item 1205 and added to the repository represented at item 1206. At item 1207, the standard usage metrics sent to the network provider are converted to the format specified at item 1208 and added to the repository represented at item 1209.

At item 1210, it is determined whether the Clearinghouse was specified to be part of this transaction. If so, the usage metrics at item 1202 are sent to the Clearinghouse at item 1211. At item 1212, the Clearinghouse process is completed as described in FIG. 13 and the process ends. If no Clearinghouse is specified, the process ends.

It is appreciated that the service provider and the network provider could be the same entity, allowing items 1203 and 1207-1209 to be skipped.

If the Clearinghouse is not specified, network provider and the service provider use the billing information generated in this Billing Process illustrated in FIG. 12 and reconcile the amounts in accordance with their standard operating procedures and all processes have ended. If the Clearinghouse process is specified, we move to the operations illustrated in FIG. 13.

Embodiments enable the creation of a temporary business relationship between a network provider and a service provider who may have never had any prior business relationship. This embodiment allows network providers and service providers an additional measure of financial control by agreeing to have the clearing of the amounts owed as a result of the network sharing agreement handled by a third party clearinghouse. One embodiment allows a network provider to refuse to agree to a network share unless the service provider agrees to use the Clearinghouse. One embodiment allows a service provider to refuse to agree to a network share unless the network provider agrees to use the Clearinghouse. These embodiments are noted in items 624 and 625 on FIG. 6.

At item 1301, transactions are read from a pool at item 1302. At item 1303, the pool at item 1302 is searched for a transaction matching the one found in 1301. If, at item 1304, a matching transaction is found, it is determined at item 1305 if the dollar amounts match. It is appreciated that not only must the dollar amounts match, but also one transaction found must be a debit and the other must be a credit. If there is a match at item 1305, the matching transactions are added to a pool at item 1309. At item 1307, it is determined if there are more transactions to process. If so, the process returns to item 1301 and restarts. If, at item 1307, there are no more transactions to process, the process moves to item 1310.

At item 1310, the pooled transactions at item 1309 are aggregated to one sum per provider. Any debit balances are collected at item 1311 and aggregated, in one embodiment, in one financial account at item 1312. At item 1314, the aggregated credit balances collected in item 1311 are compared with the total credit balances via the information in item 1313. If the debit and credit balances match at item 1314, the credit balances are remitted at item 1315. A Clearinghouse activity report is then sent to network providers and service providers at item 1316 and the process ends. If the debit balances and credit balances at item 1314 do not match, the process moves to an exception database at item 1306.

If, at item 1305, there is no dollar match for a matched pair of transactions, the transactions are moved to an exception database at item 1306.

Items 1308-1310 assume an embodiment where multiple transactions are pooled before processing in items 1311-1316 is completed. Someone familiar with the art having the benefit of this disclosure should realize matched transactions could be processed immediately without pooling, essentially moving the process from matching amounts at item 1305 directly to item 1311.

In one embodiment, item 1306 represents a collection of data exceptions and anomalies that will need to be rectified via human intervention. This is in contrast to the other embodiments that, with the exception of initial setups, are wholly automatic.

An embodiment shown in FIG. 16 describes the high-level processes that occur within Port components and Director components. Each of these processes is described in detail above. Item 1601 illustrates processes that occur on the Port component, and item 1602 illustrates processes that occur on the Director component. Each process has a corresponding figure that illustrates its function, described above.

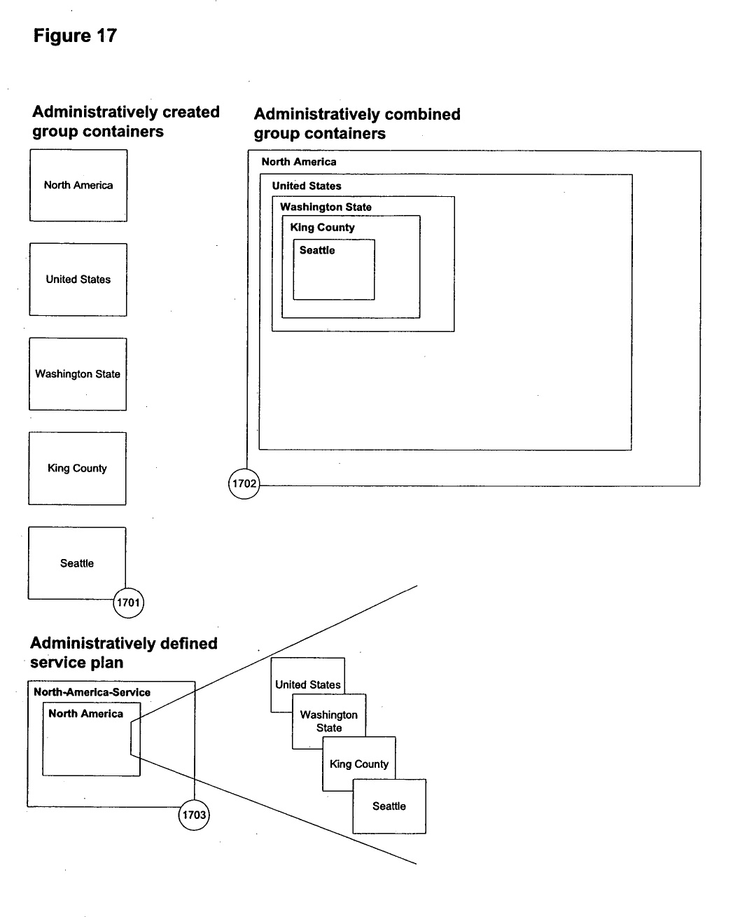

An embodiment shown in FIG. 17 describes group containers and their utility for (but not limited to) managing Port components and resources, location-based roaming, and creating sophisticated service plans. The illustration in FIG. 17 uses, by way of example and not by limitation, the concepts of geographically based groups. The use of geographical-based groupings is to illustrate the concept, not to limit this embodiment to geographically based groups. It should be appreciated by someone familiar with the art other, non-limiting examples, could include venue types, venue owners, sales territories, and/or to enable use of a wide variety of business rules in different embodiments.

In an embodiment, the Director component utilizes group containers (as shown in item 1701) for management purposes and authorization processes. A group is a logical container for Port component(s) and other groups. Because a group can contain other groups (item 1702), a Port component can belong to multiple groups. It is appreciated that in other embodiments groups can also contain resources (by way of example and not limitation printing, instant messaging, etc.) that describe additional group functionality. For example, and not by way of limitation, if the venue where the Port component resides has a printing kiosk available to patrons, a printer resource could be placed within the group container in addition to the Port component. This example would allow both the Port component and printer resource to be utilized when creating service plans. Continuing this example, a service provider might create a service plan that allows an end user to use printing resources. Someone familiar with the art having the benefit of this disclosure would appreciate many different types of resources being applicable to group containers and their integration with manageability in many different aspects, be it the creation of service plans, group configurations, and etc.

In an embodiment, Port components (and resources) are registered with the Director component that controls it, and during this registration process the Port component is either added to a new group or an existing group. In a related embodiment, groups may be used to create service plans (as shown in item 1703) within the Director component. Groups are only utilized to logically group Port components and resources for use by authorization engines within the invention, distinct from authentication (e.g., username/password). By way of example and not by way of limitation, just because an end user successfully enters his/her username and password doesn't mean he/she is authorized to connect at a particular location or to a particular resource. An embodiment of the Director component uses the RADIUS protocol to communicate with attached business support systems. One might use RADIUS vendor specific attributes (VSA) that denote the service plan or group that an end user belongs to. This VSA would correspond to the name of the group container that represents the end user's service plan, creating a link between the embodiment's notion of group containers and the business support system(s). Using such an approach creates significant flexibility in the authorization processes outlined previously. One familiar with the art would appreciate that communication with business support systems can occur with a multitude of protocols and RADIUS is merely an example.

In an embodiment, configuration information can be sent to multiple Port components by selecting a group container. All Port components defined within a group (including those within subgroups) will receive the configuration information. One familiar with the art having the benefit of this disclosure would appreciate that certain configuration information, such as network settings, should not be identical across a group of managed objects, and therefore are not applicable to certain group configurations. Network settings, such as network interface address, is used by way of example, and is appreciated to be non-limiting.

In an embodiment, Director components also have the ability to automatically create group containers and assign Port components and resources appropriately. If a physical address is entered for the venue location where the Port component or resource is located, hierarchies of groups are created for the continent, country, state, county, and city. As other Port components and resources are added to the Director component's control, they are appropriately added to existing groups or new groups. For flexible administration, Port components and resources are easily moved between groups.

In one embodiment, Port components allow a network provider to specify unique business rules for each venue or portion of a venue. These business rules are entered at the time the Port component is first registered with the Director component. In this embodiment, the network provider is able to specify different business rules for different venues. By way of example and not limitation, the most obvious business rule is pricing. In this embodiment, the network provider is able to assign different prices for public network access in different venues. This embodiment is illustrated in 19-a. Those familiar with the art will appreciate while the venue chosen for an illustration is an airport terminal, the venue where the Port component is located can be of any type, including an outdoor location where there is no real “venue” at all.

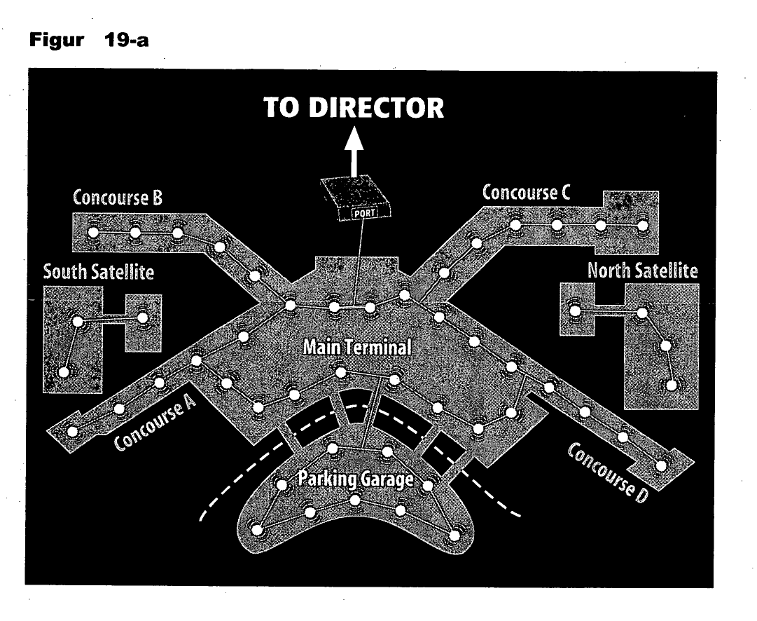

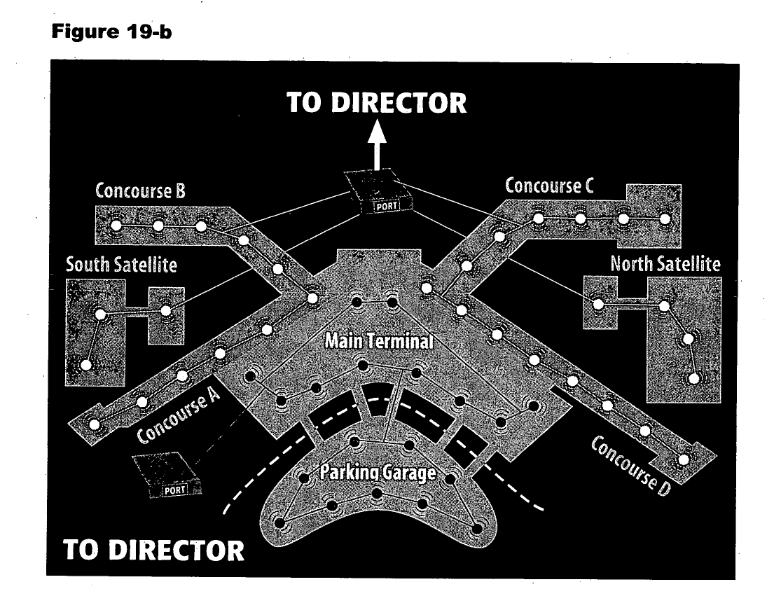

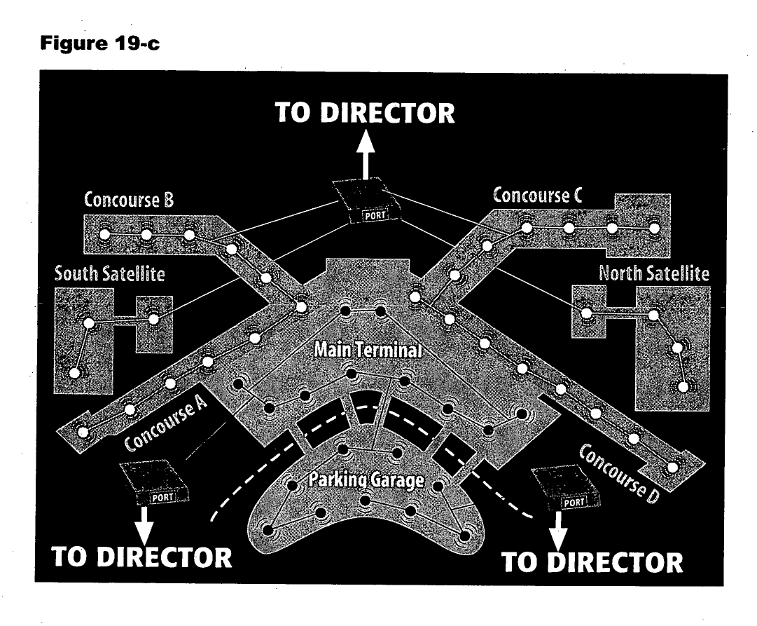

An additional embodiment is illustrated in 19-b. While only one Port component is required for a venue, the network provider may choose to add additional Port components to achieve additional flexibility in specifying business rules. In FIG. 19-b, one Port component is assigned to network access points (the dots) in Concourses B and C and the North and South Satellites. A second Port component is assigned to network access points in the Main Terminal and the Parking Garage. In this non-limiting example configuration, the network provider could charge one price to end users connecting in the Main Terminal and the Parking Garage and a separate price to end users connecting elsewhere in the venue. FIG. 19-c illustrates an additional example where a portion of the parking garage is segmented by the addition of a third Port component and can therefore be assigned a third set of business rules.

Service providers are able to make use of several components of an embodiment to offer a broad variety of service plans to end users. In FIG. 1, it is noted the service provider's Director component is attached to the service provider's business support systems (BSS). The BSS is the service provider's authentication, authorization, and accounting data repository. Those familiar with the art having the benefit of this disclosure will understand that the BSS may be located on the same computing appliance as the Director component or located in multiple buildings scattered across the planet but connected by a data network.

In an embodiment, the BSS system is sophisticated enough to handle a multitude of authorization parameters. Example parameters were discussed above in connection with FIG. 10. FIG. 17, while intended to illustrate relationships between Director components and Port components, also illustrates another set of potential authorization parameters. The description of the All Access Pass embodiment above in connection with the discussion of FIG. 6 illustrates another set of potential authorization parameters. The authorization parameters noted in this paragraph are by way of example and not limitation.

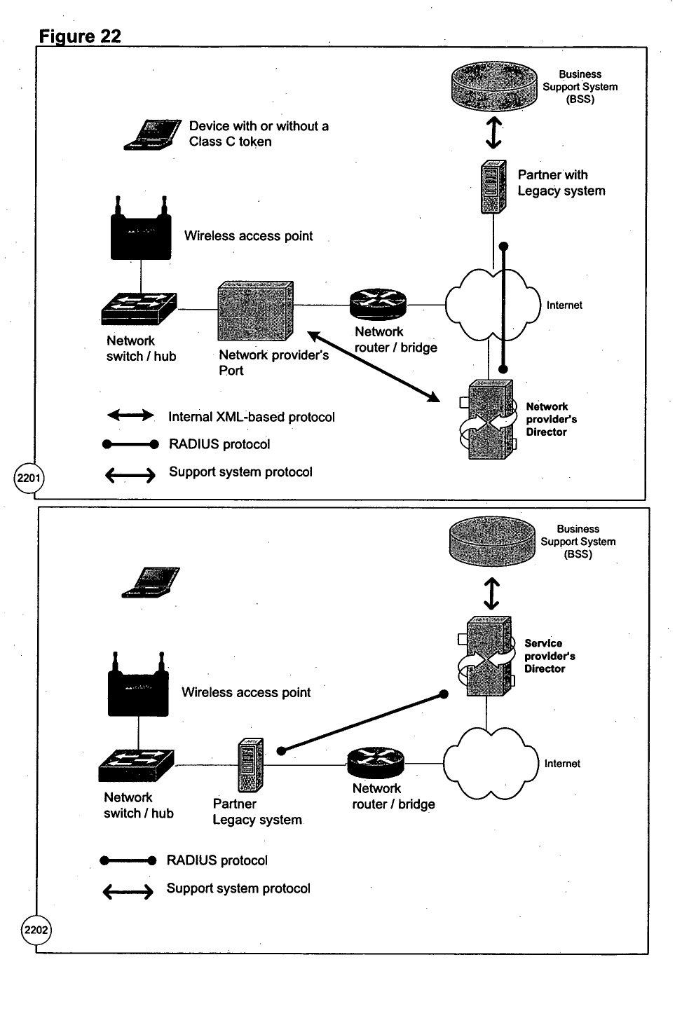

FIG. 22 illustrates an embodiment that is compliant with legacy systems. Although the embodiment extends and simplifies use of public access networks, many legacy systems remain in use and therefore the embodiment remains interoperable with these legacy systems. Legacy systems utilize the RADIUS protocol(by way of non-liming example—realms) to proxy authentication, authorization, and accounting (AAA) requests to the correct service provider's RADIUS authentication server. For this reason, Director components (and Port components as described in an embodiment that supports 802.1x authentication) expose RADIUS server functionality for communication with RADIUS client authenticators.

Item 2201 illustrates a situation where the network provider uses an embodiment of the invention, and the service provider uses a legacy RADIUS system. It is first important to recognize that legacy systems rely on pre-negotiated network sharing agreements to facilitate roaming. This is because RADIUS realms (e.g., a service provider's domain name) must be pre-configured to route RADIUS authentication requests to the correct RADIUS server. Although embodiments can dynamically create session based sharing agreements even when a network provider and service provider have no prior business relationship (as described above), backward-compatibility with legacy systems require partner agreements to be pre-configured. Legacy partners are listed in the PartnerAccept database segment (described above and illustrated in item 610) and designated as legacy partners.

In an embodiment, when an end user of a service provider using a legacy system has a class ‘C’ token on their device (as noted earlier, a class ‘C’ token denotes a legacy service provider), the Director component will use the configured legacy protocol to authenticate, authorized, and account for usage for the end user's session with the end user's service provider. In another embodiment, the end user's device does not have a class ‘C’ token. As described above in the Service Provider Determination process, (described above and illustrated in FIGS. 3, 4, and 5) if the end user's legacy service provider is listed in the PartnerAccept database segment of the network provider's Director, the end user can be authenticated and authorized to use the network.

In another situation, as illustrated in item 2202, the network provider uses a legacy system, and the service provider uses an embodiment. Again, because the embodiments are interoperating with a legacy system, a pre-negotiated network share agreement must be configured in the service provider's PartnerAccept database segment, and the service provider's RADIUS realm must be configured in the network provider's legacy system in order to route AAA information properly. Because the network provider uses a legacy system in this embodiment, tokens on the end user's device are ignored and only basic network functionality is available.

In embodiments where a network provider uses a legacy system, a service provider may not be able to implement restrictions or process advanced service plans as described above. The lowest common denominator in embodiments related to legacy systems is the legacy system, and all systems are limited by the functionality therein.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments, including what is described in the Abstract, is not intended to be exhaustive or to limit the invention to the precise forms disclosed. While specific embodiments and examples are described herein for illustrative purposes, various equivalent modifications are possible within the scope of the invention and can be made without deviating from the spirit and scope of the invention.

For example, while various communication protocols and formats (such as 802.1x and RADIUS) have been described herein for illustrative purposes, it is appreciated that other embodiments may use other types of communication protocols, formats, standards, etc.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A system, comprising:
at least one port component through which an end user needs to be authenticated and authorized in order to access a network resource via a network provider's network, the port component being able to enforce an access policy and to apply rules of a service provider of the end user during the end user's use of the network provider's network;
at least one first director component communicatively coupled to the port component to provide the access policy to be used in connection with the network provider's grant of access to its network;
at least one second director component communicatively coupled to the first director component to provide the access policy to the first director component in connection with the service provider's request for access to the network provider's network on behalf of its end user and in connection with authentication and authorization of the end user; and
a home provider register (HPR) component communicatively coupled to the first director component to be used by the first director component in connection with determination of a service provider of the end user.

2. The system of claim 1, further comprising a business support system (BSS) component communicatively coupled to the director component, from which the Director component obtains data associated with the access policy.

3. The system of claim 1 wherein different director components are associated with the network provider and with the service provider, the director components of these providers being able to communicate with each other to provide the access policy to the port component to allow the user to access the network resource via the network provider's network.

4. The system of claim 1 wherein the network provider and the service provider have no existing network share agreement between them.

5. The system of claim 4 wherein, if the end user is authenticated and authorized to access the network resource via the network provider's network, the network share agreement is established between the network provider and service provider for the duration of the end user's access of the network provider's network.

6. The system of claim 1 wherein the network provider and the service provider have an existing network share agreement between them.

7. The system of claim 1, further comprising a provider revocation list communicatively coupled to the director components, and usable to verify whether there is a denial of service for either the service provider and the network provider.

8. The system of claim 1 wherein alternatively or additionally to the HPR, the director component is able to determine the service provider of the end user based on at least one of token information, multiple tokens corresponding to multiple providers, identification information on a device being used by the end user, email address of the end user, an open search interface technique, a RADIUS technique, and user-input data provided by the end user.

9. The system of claim 8 wherein the director component is able to determine the service provider of the end user without requiring additional hardware and software on the device used by the end user.

10. The system of claim 1 wherein if the service provider is unavailable or if an agreement between the service provider and network providers cannot be made, the network provider through the director component can associate the end user with a preferred service provider.

11. The system of claim 1 wherein the port component is further able to track accounting data for each end user and to shape service metrics according to a service plan of the service provider.

12. The system of claim 1 wherein the port component is further able to use a heartbeat process to monitor activity of the end user, if authenticated, for purposes of billing and to verify that no end user sessions are left open.

13. The system of claim 1 wherein at least one of the director components is able to securely perform at least one of:
determine a network-share agreement between the network provider and the service provider, if any;
import brand information of the service provider to the port component to deliver to the user;
communicate authentication credentials of the end user to the service provider;
communicate, to the port component, whether to allow or deny access to the end user and impose the restrictions from the service provider, if any; and
communicate accounting information to the network provider and to the service provider as part of a network share arrangement.

14. The system of claim 1, further comprising at least one of the following network sharing components:
a PartnerAccept component that identifies pre-negotiated cross-license terms between the network provider and the service provider;
a billing component wherein end-user usage metrics collected by the port component are transmitted to the network provider and the service provider for accounting purposes;
a Clearinghouse component to coordinate and ensure payment to the network provider from the service provider as a result of allowing access to the end user;
an AutoAccept component to determine a minimum compensation that a network provider will accept to allow access to its network by end users of the service provider;
an AutoPay component to determine a maximum compensation that a service provider will pay to allow its users to access a network provider's network; a first AutoRefuse component to specify service providers whose end users are banned from accessing a network provider's network; and
a second AutoRefuse component to specify network providers whose networks are banned from use by a service provider's end users.

15. The system of claim 14, further comprising an All Access Pass component in which the end user is allowed access to any network provider's network by agreeing to network provider's payment metrics, provided no AutoRefuse component exists for either the network provider or the service provider.

16. The system of claim 1 wherein the service provider, through the port component, is able to enforce its rules on its end user while accessing the network provider's network that is not owned by the service provider.

17. The system of claim 1 wherein a plurality of port components are associated with a corresponding plurality of different pricing metrics.

18. The system of claim 1 wherein the system allows the end user to roam amongst different network providers' networks.

19. The system of claim 1 wherein at least one of port components, network resources, service provider rules, management operations, and geographic locations are organized based on group containers.

20. The system of claim 19 wherein at least one of the group containers is used in connection with authorization.

21. The system of claim 1 wherein the director component is communicatively coupled to a legacy system.

22. The system of claim 1 wherein at least some of the director components and the port component are distributed.

23. The system of claim 1 wherein at least some of the director components, port component, and HLR component are scalable to accommodate additional end users, network providers, or service providers.

24. A system, comprising:
a means for allowing an end user, associated with a service provider, to use a network provider's network that is not managed by the service provider;
a means for determining the service provider of the end user of the network provider's network; and
a means for automatically and dynamically facilitating network sharing agreements between the network provider and the service provider, including a means for applying the service provider's rules to the end user while the end user uses the network provider's network.

25. The system of claim 24, further comprising means for authorizing and authenticating the end user to the network provider's network.

26. The system of claim 24, further comprising a means for using a preferred provider if the service provider of the end user is unavailable or if a network share agreement between the network provider and the service provider cannot be implemented.

27. The system of claim 24 wherein the means for allowing the end user to use the network provider's network includes:
at least one first component means for accessing the network provider's network;
at least one second component means for managing the end user's use of the network provider's network; and
at least another second component means for restricting usage to only end user's whose service provider is willing to agree to network sharing terms

28. The system of claim 27 wherein the at least one first component means includes means for applying different pricing policies to different first component means.

29. The system of claim 24, further comprising a heartbeat means for monitoring activity of the user for purposes of billing and to verify that no user sessions are left open.

30. The system of claim 24, further comprising a plurality of different payment means for implementing billing associated with servicing the user.

31. The system of claim 30 wherein one of the payment means includes an All Access Pass means for allowing the end user to access any network provider's network subject to payment policies of these network providers and provided that another billing component of either the network provider and the service provider do not preclude access.

32. The system of claim 24, further comprising container means for defining access and network use privileges.

33. The system of claim 24, further comprising means for allowing access to and use of legacy systems.

34. The system of claim 24, further comprising a means for importing a brand or content of the service provider to the network provider's network during use by the end user.

35. The system of claim 24, further comprising device means for accessing the network provider's network, and network means within the network provider's network for supporting the device means' access and use of the network provider's network.

36. The system of claim 24, further comprising a means for using multiple tokens in different classes to represent different service provider states.

37. The system of claim 24, further comprising means for distributing and scaling to accommodate additional network providers, service providers, or users.

38. A method, comprising:
authenticating and authorizing a user to access a network resource via a network provider's network;
providing an access policy to be used in connection with the authenticating and authorizing;
determining a service provider of the user, the service provider not being substantially involved in managing use of the network provider's network; and
enforcing the access policy and applying rules of the service provider during the user's use of the network provider's network.

39. The method of claim 38 wherein providing the access policy includes providing the access policy based on data from a business support system.

40. The method of claim 38, further comprising communicating between different director components to obtain service provider rules and access policies.

41. The method of claim 38, further comprising implementing either a new or existing network share agreement between the network provider and the service provider.

42. The method of claim 41 wherein implementing the new network share agreement including implementing terms of the new network share agreement only for the duration of the end user's use of the network provider's network.

43. The method of claim 38 wherein if the service provider is unavailable or if an agreement between the service provider and network provider cannot be made, the method includes associating the end user with a preferred service provider.

44. The method of claim 38, further comprising using a heartbeat process to monitor activity of the end user for purposes of billing and to verify that no end user sessions are left open.

45. The method of claim 38, further comprising implementing at least one of the following service payment components:
a PartnerAccept component that identifies pre-negotiated cross-license terms between network providers and service providers;
a billing component that distributes accounting information to the service provider and the network provider as a result of allowing access to the end user
a clearinghouse component to coordinate and attempt to ensure payment to the network provider from the service provider as a result of allowing access to the end user;
an AutoAccept component to determine a minimum compensation that a network provider will accept to allow access to its network by a service provider's end users;
an AutoPay component to determine a maximum compensation that a service provider will pay to allow its end users to access a network provider's network;
a first AutoRefuse component to specify service providers whose end users are banned from accessing a network provider's network; and
a second AutoRefuse component to specify network providers whose networks are banned for use by a service provider's end users.

46. The method of claim 45, further comprising implementing an all access pass to allow the end user to access any network provider's network subject to billing policies of these network providers, provided that at least one of the AutoRefuse components does not negate a network share between the network provider and the service provider.

47. The method of claim 38, further comprising managing access and use of network resources based on group container definitions.

48. The method of claim 38, further comprising disabling capability to access a network resource based on provider revocation settings.

49. The method of claim 38, further comprising importing brand and content information of the service provider to the network provider's network during use of that network by the end user.

50. The method of claim 38, further comprising implementing network authorization, access, and use in conjunction with legacy systems.

51. The method of claim 38, further comprising implementing different pricing policies for different port components that can be used by the end user to access the network provider's network.

52. The method of claim 38 wherein determining the service provider of the end user includes determining the service provider without requiring additional hardware and software on a device used by the end user.

53. An article of manufacture, comprising:
a machine-readable medium having instructions stored thereon to:
authenticate and authorize an end user to access a network resource via a network provider's network;
provide an access policy to be used in connection with the authenticating and authorizing;
determine a service provider of the end user, the service provider not being substantially involved in managing use of the network provider's network; and
initiate enforcement of the access policy and application of rules of the service provider during the end user's use of the network provider's network.

54. The article of manufacture of claim 53 wherein the machine-readable medium further includes instructions stored thereon to initiate implementation of either a new or existing network share agreement between the network provider and the service provider.

55. The article of manufacture of claim 53 wherein the machine-readable medium includes at least one of instructions stored thereon to:
determine a network-share agreement between the network provider and the service provider, if any;
import brand and content information of the service provider to be delivered to the end user;
communicate authentication credentials of the end user to the service provider;
communicate whether to allow or deny access to the end user and impose the restrictions from the service provider, if any; and
communicate accounting information to the network provider and to the service provider as part of a network share arrangement.

56. The article of manufacture of claim 53 wherein the machine-readable medium further includes instructions stored thereon to monitor use of the network provider's network by the end user.

57. The article of manufacture of claim 53 wherein the machine-readable medium further includes instructions stored thereon to disable capability to access a network resource based on provider revocation settings.
